(19) United States
(12) Patent Application Publication
(10) Pub. No.: US 2023/0007686 A1
(43) Pub. Date: Jan. 5, 2023

(54) Random Access Channel Performance Reporting in Unlicensed Networks

(71) Applicant: Telefonaktiebolaget LM Ericsson (publ), Stockholm (SE)

(72) Inventors: Marco Belleschi, Solna (SE); Pablo Soldati, Solna (SE); Icaro L. J. Da Silva, Solna (SE); Ali Parichehrehteroujeni, Linköping (SE); Angelo Centonza, Granada (ES); Pradeepa Ramachandra, Linköping (SE)

(21) Appl. No.: 17/780,338

(22) PCT Filed: Feb. 12, 2021
(86) PCT No.: PCT/SE2021/050125

§ 371 Date: May 26, 2022

Related U.S. Application Data
(60) Provisional application No. 62/979,515, filed on Feb. 21, 2020.

(51) Int. Cl. H04W 74/08

(52) U.S. Cl. CPC H04W 74/0808; H04W 74/0833

(57) ABSTRACT

A user equipment, UE (105), makes a plurality of attempts at random access to an access node (110). The UE transmits, to the access node (110), a report comprising Listen Before Talk, LBT, diagnostic data for each of the attempts at random access. The access node (110) receives, from the UE (105), the report and configures the UE (105) with an adjusted random access resource allocation based on the LBT diagnostic data of at least one of the attempts at random access.

### RELATED APPLICATIONS

This application claims priority to U.S. Application No. 62/979,515, filed 21 Feb. 2020, disclosure of which is incorporated in its entirety by reference herein.

### TECHNICAL FIELD

Embodiments of the present disclosure generally relate to the technical field of wireless communication and more particularly to reporting random access performance of a user equipment to an access node of a wireless communication network.

### BACKGROUND

Next generation systems are expected to support a wide range of use cases with varying requirements ranging from fully mobile devices to stationary Internet of Things (IoT) or fixed wireless broadband devices. The traffic pattern associated with many use cases is expected to consist of short or long bursts of data traffic with varying length of waiting period in between. This waiting period is herein referred to as “inactive state.” In New Radio (NR), both License Assisted Access (LAA) and standalone unlicensed operation are to be supported.

Allowing unlicensed networks (i.e., networks that operate in shared or unlicensed spectrum) to effectively use the available spectrum is an attractive approach to increasing system capacity. Although unlicensed spectrum does not match the qualities of the licensed regime, solutions that allow an efficient use of the unlicensed spectrum as a complement to licensed deployments have the potential to bring great value to Third Generation Partnership project (3GPP) operators, and, ultimately, to the 3GPP industry as a whole. For this reason, 3GPP has spent significant effort in specifying operations for LAA in Long Term Evolution (LTE), and NR-Unlicensed (NR-U) in NR.

When operating in unlicensed spectrum many regions in the world require a device to sense the medium as free before transmitting. This operation is often referred to as Listen Before Talk (LBT). There are many different flavors of LBT, depending on which radio technology the device uses and which type of data it wants to transmit at the moment. Common for all known flavors is that the sensing is done in a particular channel (corresponding to a defined carrier frequency) and over a predefined bandwidth. For example, in the 5 GHz band, the sensing is done over 20 MHz channels. Many devices are capable of transmitting (and receiving) over a wide bandwidth including multiple sub-bands/channels, e.g., LBT sub-band (i.e., wherein the frequency part with bandwidth equals the LBT bandwidth). A device is only allowed to transmit on the sub-bands where the medium is sensed as free. Such an LBT procedure has to be performed by both the base station, and the User Equipment (UE), whenever they intend to transmit something on the unlicensed spectrum, regardless of the type of uplink or downlink transmission being made. That is, the LBT procedure is generally required for both data and control signaling at any layer (e.g., Layer 1/2/3).

More particularly, LBT is traditionally designed for the unlicensed spectrum to ensure a fair coexistence with other Radio Access Technologies (RATs). In this mechanism, a radio device applies a clear channel assessment (CCA) check (i.e., channel sensing) before any transmission. The transmitter considers energy detection (ED) over a time period compared to a certain threshold (ED threshold) in order to determine if a channel is idle. If the channel is determined to be occupied, the transmitter performs a random back-off within a contention window before making another CCA attempt. In order to protect Acknowledgement (ACK) transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MOOT)).

For Quality of Service (QoS) differentiation, a channel access priority based on the service type has been defined. For example, there are four known LBT priority classes that are defined for differentiation of contention window sizes (CWSs) and MOOT between services. Therefore, the LBT class selected for a transmission depends on the priority of the data to transmit or on the type of signal to transmit, e.g., depending on whether the signal is a Physical Random Access Channel (PRACH), Physical Uplink Control Channel (PUCCH), or Radio Resource Control (RRC) signal.

NR also supports the classical 4-step random access procedure (which is present also in LTE), and a newer 2-step random access procedure that has been specified as part of the 3GPP Rel-16 standard. From the signaling diagrams of FIG. 1A and FIG. 1B, the differences between the traditional 4-step Random Access Channel (RACH) procedure (top) and the newer 2-step RACH procedure (bottom) can be readily appreciated.

A clear advantage of the 2-step RACH procedure over the 4-step RACH is that the 2-step RACH is much faster. In particular, it is possible to show that the minimum latency that can be achieved between the PRACH transmission until msg4 reception (i.e. contention resolution, with the 4-step RACH) is 13 subframes. By comparison, for 2-step RACH, the minimum achievable latency is 4 subframes. This makes 2-step RACH approximately 3 times faster than 4-step RACH. Therefore, the 2-step RACH approach may be particularly attractive for delay-sensitive use cases, and also in unlicensed networks. That is because the 2-step approach, unlike the 4-step approach, implies only 2 LBT procedures (one at the UE side for msgA transmission, and one at the network side for the msgB transmission), thereby making the 2-step much faster especially in case of congested network where the UE and/or gNodeB (gNB) may need to postpone the transmission of random access (RA) messages several times due to LBT failures (e.g., a busy channel).

On the other hand, in 2-step RACH, the UE may transmit data (i.e. the payload) as part of msgA (i.e., before getting a proper uplink timing alignment from the network). Additionally, data transmitted in msgA have not yet been link adapted by the network. This means that the probability of properly decoding the payload at network side very much depends on how good uplink synchronization already is. For example, the probability of properly decoding the payload may depend on the cell size, and also on how good the link quality is. Given the above, assuming that the Bandwidth Part (BWP) selected for the random access procedure has both 4-step and 2-step RACH resources configured, the UE traditionally selects the 2-step RACH resources only if the estimated downlink Resource Signal Receive Power (RSRP) is above a certain configurable threshold.

Similar to the 4-step RACH, the UE can select a RACH preamble from two groups of 2-step RACH preambles, depending on the size of the payload to include in msgA. At transmission of 2-step RACH, the UE starts the msgB-ResponseWindow timer and starts monitoring the Physical Downlink Control Channel (PDCCH) with msgB-RNTI. If no msgB is received within msgB-ResponseWindow, or if the gNB sends a msgB that includes a backoff indicator, the UE reattempts msgA transmission and applies power ramping. Otherwise, the network may include a successRAR flag in the msgB to indicate that msgA (preamble+payload) decoding was successful. In this case, if the UE contention resolution identity included in msgB matches the one included by the UE in msgA, the random access procedure is considered successful and the UE will use the Cell Radio Network Temporary Identifier (C-RNTI) included in the msgB for successive communications with the network.

The network may also include in the msgB a fallback indicator to indicate to the UE a fallback to 4-step RACH procedures. The fallback procedure may be used, for example, when the network successfully decodes the preamble, but is not able to decode the payload in msgA. Therefore, if the msgB Medium Access Control (MAC) Protocol Data Unit (PDU) with fallbackRAR includes a Random Access Preamble Identifier (RAPID) which matches the preamble index used by the UE in msgA, the UE continues with msg3 transmission using the uplink grant and the Temporary C-RNTI included in msgB. Hence, the UE moves the payload intended to be transmitted in msgA to the msg3 buffer, and it waits for msg4 to resolve the contention.

Finally, a switch procedure is also considered in the relevant 3GPP specification. The UE switches from 2-step RACH to 4-step RACH after attempting the 2-step RACH transmission a certain amount of times with no success. Unlike the fallback procedure, the switch procedure implies that the UE drops the 2-step RACH resources, and restarts from 4-step msg1 by selecting a new 4-step RACH resource.

As previously discussed, random access messages (including the PRACH) are also subject to LBT before being transmitted. In NR-U, an LBT counter is stepped whenever an uplink transmission fails in a certain BWP. When the LBT counter reaches a maximum value within a certain time, the UE declares “consistent LBT failure” for the corresponding BWP. If the affected BWP is in the Primary Cell (PCell) or the Primary Secondary Cell (PSCell), the UE deactivates the affected BWP and activates another already configured BWP in the PCell/PSCell and transmits random access therein. On the other hand, if the affected BWP is an SCell, the UE stops transmitting in this SCell, and can send a Scheduling Request (SR) on another SCell, PCell, and/or PSCell for further communications. Additionally, as a result of the consistent LBT failure, the UE issues a MAC Control Element (CE) to indicate to the network which cells are the problematic cells in which “consistent LBT failures” were experienced.

In the case of the PCell being affected, once the UE has attempted random access in all the BWPs in the PCell with no success, the UE declares a Radio Link Failure (RLF) and may attempt connection reestablishment. Similarly, for the case of the PSCell, the UE declares a Secondary Cell Group (SCG) failure when consistent uplink LBT failures have been experienced in all the BWPs of the PSCell.

Minimization Drive Test (MDT) reporting has been used in 3GPP cellular communication since Release 9 and recently extended to NR in 3GPP Release 16. Traditionally, the purpose of MDT is for the UE to store information about different measurements that the UE may perform both in idle and connected mode. Typical measurements that the UE may log are the qualities of the cells that the UE traverses when moving, or statistics about transmission delays the UE experiences, and/or events such as RLF and/or handover failures. Such reports may then be requested by the network and used for different purposes, such as coverage optimization, mobility optimization, capacity optimization, QoS verification, and ultimately Self-Organizing Network (SON) actions.

In particular, related to RACH, a new MDT RACH signaling mechanism was introduced in Release 16. The new RRC signaling is shown in the ASN.1 code of FIGS. 2A and 2B. For each successful random access procedure, the UE signals an RA-Report element. For each attempted random access, the UE includes a perRAInfo element, which in turn contains the ssb-Index (or the Channel State Information Reference Signal (CSI-RS) index) associated with such preamble transmission, the number of preambles sent for this ssb-Index, information related to whether contention resolution was successful or not, and the experienced downlink RSRP quality. Such RACH-related information can be also sent as part of the RLF report or handover failure report as shown in the ASN.1 code of FIGS. 2A and 2B.

A traditional Fifth Generation (5G) Radio Access Network (RAN) (NG-RAN) architecture is depicted and described in TS 38.401 version 15.5.0, an example of which is provided in FIG. 3. The NG-RAN consists of a set of gNBs (i.e., 5G base stations) connected to the 5G Core (5GC) through the NG interface. A gNB can support Frequency Division Duplexing (FDD) mode, Time Division Duplexing (TDD) mode or dual mode operation. In the 5G architecture, gNBs can be interconnected through the Xn interface. A gNB may consist of a gNB Central Unit (gNB-CU) and gNB Distributed Units (gNB-DUs). A gNB-CU and a gNB-DU are connected via an F1 logical interface. Typically, one gNB-DU is connected to only one gNB-CU. However, for resiliency, a gNB-DU may be connected to multiple gNB-CUs by appropriate implementation.

The NG, Xn and F1 interfaces are logical interfaces. The NG-RAN is layered into a Radio Network Layer (RNL) and a Transport Network Layer (TNL). The NG-RAN architecture, (i.e., the NG-RAN logical nodes and interfaces between them) is defined as part of the RNL. For each NG-RAN interface (NG, Xn, F1) the related TNL protocol and the functionality are specified. The TNL provides services for user plane transport and signaling transport. If security protection for control plane and user plane data on the TNL of NG-RAN interfaces has to be supported, Network Domain Security/Internet Protocol (NDS/IP) is applied (e.g., as specified in 3GPP TS 33.401).

A gNB may also be connected to an LTE eNB (i.e., a Fourth Generation (4G) base station) via the X2 interface. According to another architectural option, an LTE eNB connected to the Evolved Packet Core (EPC) network is connected over the X2 interface to a so-called en-gNB, which is a gNB not connected directly to a Core Network (CN) and connected via X2 to an eNB for the sole purpose of performing dual connectivity.

The architecture in FIG. 3 can be expanded by spitting the gNB-CU into two entities, as shown in FIG. 4. In the split architecture option, the RAN protocol stack functionality is separated into different parts. The Central Unit Control Plane (CU-CP) is expected to handle the RRC layer, the Central Unit User Plane (CU-UP) handles the Packet Data Convergence Protocol (PDCP) layer, and the Distributed Unit (DU) handles the Radio Link Control (RLC), MAC, and Physical (PHY) layers of the protocol stack. Some implementations have a further split in which the DU can have a separate unit that handles the PHY parts separately from the RLC and MAC layers, which are handled in the DU.

As different units handle different protocol stack functionalities, inter-node communication between the DU, the CU-UP and the CU-CP may be required. This inter-node communication is achieved via the F1-C interface (relating to control plane signaling), via the F1-U interface (relating to user plane signaling for communication between CU and DU) and via the E1 interface (for communication between CU-UP and CU-CP).

The E1 interface is a logical interface. It supports the exchange of signaling information between the endpoints. From a logical standpoint, the E1 is a point-to-point interface between a gNB-CU-CP and a gNB-CU-UP. The E1 interface enables exchange of UE associated information and non-UE associated information. The E1 interface is a control interface and is not used for user data forwarding.

### SUMMARY

Embodiments of the present disclosure include a method of reporting random access information to an access node. The method is performed by a user equipment (UE) in a wireless communication network and comprises making a plurality of attempts at random access to the access node. The method further comprises transmitting, to the access node, a report comprising Listen Before Talk (LBT) diagnostic data for each of the attempts at random access.

In some embodiments, making the plurality of attempts at random access comprises making at least one attempt at 2-step random access.

In some embodiments, making the plurality of attempts at random access comprises making at least one attempt at 4-step random access.

In some embodiments, making the plurality of attempts at random access comprises making at least one attempt at 2-step random access after making at least one attempt at 4-step random access.

In some embodiments, making the plurality of attempts at random access comprises making at least one attempt at 4-step random access after making at least one attempt at 2-step random access.

In some embodiments, the method further comprises receiving a threshold from the access node, and selecting a 2-step random access channel resource responsive to detecting that signal quality on a downlink between the UE and the access node is above the threshold. At least one of the attempts uses the selected 2-step random access channel resource.

In some embodiments, at least one of the attempts at random access is to a Special Cell. In some such embodiments, the method further comprises experiencing LBT failures on a bandwidth part (BWPs) in at least one of the attempts at random access to the Special Cell. The method further comprises switching to a different BWP responsive to experiencing the LBT failures. Making at least one of the attempts comprises uses the different BWP for a subsequent attempt at random access to the Special Cell.

In some such embodiments, using the different BWP for the subsequent attempt at random access to the Special Cell comprises using the different BWP for 2-step random access. In other such embodiments, using the different BWP for the subsequent attempt at random access to the Special Cell comprises using the different BWP for 4-step random access.

In some embodiments, the method further comprises selecting a 4-step random access channel resource. At least one of the attempts uses the selected 4-step random access channel resource. In some such embodiments, selecting the 4-step random access channel resource is responsive to experiencing LBT failures in a previous one of the attempts.

In some embodiments, the report comprising the LBT diagnostic data is responsive to a successful one of the attempts at random access.

In some embodiments, the method further comprises experiencing multiple LBT failures with respect to a failed attempt of the plurality of attempts at random access to a Special Cell. Transmitting the report comprising the LBT diagnostic data is responsive to experiencing the multiple LBT failures.

In some embodiments, the method further comprises experiencing multiple LBT failures in each of a plurality of BWPs available for random access procedures with the access node. Transmitting the report comprising the LBT diagnostic data comprises transmitting a Radio Link Failure report responsive to experiencing the multiple LBT failures.

In some embodiments, the method further comprises postponing transmission of a message for a given attempt of the plurality of attempts at random access responsive to experiencing an LBT failure. Transmitting the report comprising the LBT diagnostic data comprises transmitting an LBT report responsive to experiencing the LBT failure.

In some embodiments, the method further comprises experiencing a number of LBT failures in excess of a threshold for a given attempt of the plurality of attempts at random access. Transmitting the report comprising the LBT diagnostic data comprises transmitting an LBT report responsive to experiencing the number of LBT failures in excess of the threshold.

In some embodiments, the method further comprises responsive to experiencing a plurality of LBT failures using a BWP of a serving cell of the access node, refraining from transmitting on an uplink of a Secondary Cell of the serving cell for attempts of the plurality of attempts subsequent to the plurality of LBT failures. Transmitting the report comprising the LBT diagnostic data comprises transmitting an LBT report responsive to experiencing the plurality of LBT failures.

In some embodiments, the method further comprises, responsive to experiencing a plurality of LBT failures using a BWP of a serving cell of the access node, switching to a different BWP for attempts of the plurality of attempts subsequent to the plurality of LBT failures. Transmitting the report comprising the LBT diagnostic data comprises transmitting an LBT report responsive to experiencing the LBT failure.

In some embodiments, the method further comprises receiving an adjusted random access resource allocation from the access node in response to the report comprising the LBT diagnostic data. In some such embodiments, the method further comprises attempting random access to the access node using the adjusted random access resource allocation. Additionally or alternatively, the adjusted random access resource allocation may comprise a changed preamble resource allocation. Additionally or alternatively, the method may further comprise the adjusted random access resource allocation excludes a BWP used for the at least one of the attempts at random access and includes a different BWP in the random access resource allocation. Additionally or alternatively, the adjusted random access resource allocation may comprise a changed Physical Downlink Shared Channel resource allocated for responding to a random access preamble transmission from the UE. Additionally or alternatively, the adjusted random access resource allocation may exclude a Physical Uplink Shared Channel resource used in at least one of the attempts at random access. Additionally or alternatively, the adjusted random access resource allocation may replace one of a 2-step Random Access Channel (RACH) resource allocation and a 4 step RACH resource allocation with the other of the 2-step RACH resource allocation and the 4-step RACH resource allocation.

In some embodiments, the adjusted random access resource allocation replaces the 4-step RACH resource allocation with the 2 step RACH resource allocation responsive to a signal quality metric indicated in the LBT diagnostic data exceeding a signal quality threshold. In some such embodiments, the adjusted random access resource allocation replaces the 4-step RACH resource allocation with the 2 step RACH resource allocation further responsive to a further signal quality metric indicated in the LBT diagnostic data being below a further signal quality threshold. Additionally or alternatively, the adjusted random access resource allocation may replace the 4-step RACH resource allocation with the 2 step RACH resource allocation further responsive to a number of LBT failures indicated in the LBT diagnostic data exceeding an LBT failure threshold. Additionally or alternatively, the adjusted random access resource allocation may replace the 4-step RACH resource allocation with the 2 step RACH resource allocation further responsive to a channel occupancy indicated in the LBT diagnostic data exceeding a channel occupancy threshold. In other embodiments, the adjusted random access resource allocation replaces the 2-step RACH resource allocation with the 4 step RACH resource allocation responsive to a signal quality metric indicated in the LBT diagnostic data being below a signal quality threshold.

In some embodiments, the method further comprises adjusting a random access message transmission power in accordance with a response to the report received from the access node.

In some embodiments, the adjusted random access resource allocation comprises both a 2-step RACH resource allocation and a 4 step RACH resource allocation. In some such embodiments, the method further comprises selecting between using the 2-step RACH resource allocation and the 4-step RACH resource allocation in a subsequent random access attempt based on a signal quality threshold received from the access node.

In some embodiments, the report is a Random Access Report. In other embodiments, the report is a Radio Link Failure Report. In yet other embodiments, the report is an LBT Report. In yet other embodiments, the report is a Connection Failure report. In still yet other embodiments, the report is a Secondary Cell Group Failure Report. In still yet other embodiments, the report is a Minimization of Drive Test Report.

In some embodiments, the LBT diagnostic data comprises diagnostic data for at least one attempt at 2-step random access.

In some embodiments, the LBT diagnostic data comprises diagnostic data for at least one attempt at 4-step random access.

In some embodiments, the method further comprises measuring, for each of the attempts at random access, an amount of time between a first event at the UE with respect to an initial random access message in the attempt, and a second event at the UE. The method further comprises including the measured amount of time between the first and second events in the LBT diagnostic data transmitted to the access node. In some such embodiments, for each of the attempts, the first event is a triggering of the UE to perform an LBT procedure in order to transmit the initial random access message. In some such embodiments, for each of the attempts, the second event is a determination by the UE that transmission of the initial random access message, after the LBT procedure, was successful; a switching of BWPs by the UE after failure of the LBT procedure; receipt of a response to the initial random access message after the LBT procedure succeeded; receipt, after transmission of the initial random access message failed, of a response to a further initial random access message transmitted by the UE in a subsequent attempt; and/or expiration of a random access response window timer.

In some such embodiments, the method further comprises measuring, for at least one of the attempts, an amount of time spent waiting for a response to the initial random access message. The method further comprises including the amount of time spent waiting for the response to the initial random access message in the LBT diagnostic data transmitted to the access node.

In some embodiments, the method further comprises measuring, for at least one of the attempts at random access, an amount of time between a third event at the UE with respect to a message on a Physical Uplink Shared Channel in the attempt, and a fourth event at the UE. The method further comprises including the measured amount of time between the third and fourth events in the LBT diagnostic data transmitted to the access node. In some such embodiments, for each of the at least one of the attempts, the third event is a triggering of the UE to perform an LBT procedure in order to transmit the message on the Physical Uplink Shared Channel. In some such embodiments, for each of the at least one of the attempts, the fourth event is one of: a determination by the UE that transmission of the message on the Physical Uplink Shared Channel, after the LBT procedure, was successful; receipt of a response to the message on the Physical Uplink Shared Channel after the LBT procedure succeeded; and expiration of a random access contention resolution timer. Additionally or alternatively, the method may further comprise measuring, for at least one of the attempts, an amount of time spent waiting for the message on the Physical Uplink Shared Channel, and including the amount of time spent waiting for the response to the message on the Physical Uplink Shared Channel in the LBT diagnostic data transmitted to the access node.

In some embodiments, the method further comprises measuring, for at least one of the attempts at random access, an amount of time between a triggering of the UE to perform an LBT procedure in order to transmit an initial random access message comprising a contention resolution identity and a further event at the UE. The method further comprises including the amount of time between the triggering and the further event in the LBT diagnostic data transmitted to the access node. For each of the at least one of the attempts, the further event at the UE is one of: receiving a successRAR message comprising the contention resolution identity in response to the initial random access message after the LBT procedure succeeded; receiving a contention resolution message comprising the contention resolution identity in response to a Physical Uplink Shared Channel transmission made by the UE in the attempt; reporting a problem with the attempt; detecting that reception of the response to the initial random access message failed; and/or detecting that reception of the response to the Physical Uplink Shared Channel transmission failed.

In some embodiments, the method further comprises including a flag in the LBT diagnostic data, wherein the flag indicates the occurrence of consistent LBT failures at the UE. In other embodiments, the method further comprises including a flag in the LBT diagnostic data, wherein the flag indicates the occurrence of consistent LBT successes at the UE, followed by a random access failure.

Other embodiments include a user equipment configured to make a plurality of attempts at random access to an access node. The user equipment is further configured to transmit, to the access node, a report comprising Listen Before Talk (LBT) diagnostic data for each of the attempts at random access.

In some embodiments, the user equipment is further configured to perform any one of the methods recited above.

In some embodiments, the user equipment comprises interface circuitry configured for communication with one or more serving cells of a wireless communication network. The user equipment further comprises processing circuitry (810) configured to make the plurality of attempts at random access to the access node, and transmit, to the access node, the report comprising the LBT diagnostic data for each of the attempts at random access. In some such embodiments, the processing circuitry is further configured to perform any one of the methods recited above.

Other embodiments include a computer program comprising executable instructions that, when executed by processing circuitry in a user equipment, causes the user equipment to perform any one of the methods recited above.

Other embodiments include a carrier containing the computer program. The carrier is one of an electronic signal, optical signal, radio signal, or computer readable storage medium.

Other embodiments include a method of managing random access resources performed by an access node in a wireless communication network. The method comprises receiving, from a user equipment, UE, a report comprising Listen Before Talk (LBT) diagnostic data for each of a plurality of attempts at random access to the access node performed by the UE. The method further comprises configuring the UE with an adjusted random access resource allocation based on the LBT diagnostic data of at least one of the attempts at random access.

In some embodiments, configuring the UE with the adjusted random access resource allocation based on the LBT diagnostic data of the at least one of the attempts at random access comprises changing, for the UE, a preamble resource allocation based on an amount of LBT experienced by the UE on a frequency in which the at least one of the attempts at random access was performed.

In some embodiments, configuring the UE with the adjusted random access resource allocation based on the LBT diagnostic data of the at least one of the attempts at random access comprises excluding, for the UE, a bandwidth part (BWP) used for the at least one of the attempts at random access from the random access resource allocation, and including, for the UE, a different BWP in the random access resource allocation.

In some embodiments, configuring the UE with the adjusted random access resource allocation based on the LBT diagnostic data of the at least one of the attempts at random access comprises changing a Physical Downlink Shared Channel resource allocated for responding to a random access preamble transmission from the UE.

In some embodiments, configuring the UE with the adjusted random access resource allocation based on the LBT diagnostic data of the at least one of the attempts at random access comprises excluding a Physical Uplink Shared Channel resource used in the at least one of the attempts at random access from subsequent use by the UE.

In some embodiments, configuring the UE with the adjusted random access resource allocation based on the LBT diagnostic data of the at least one of the attempts at random access comprises switching the UE between a 2-step Random Access Channel (RACH) resource allocation and a 4-step RACH resource allocation.

In some embodiments, configuring the UE with the adjusted random access resource allocation based on the LBT diagnostic data of the at least one of the attempts at random access comprises configuring the UE with the adjusted random access resource allocation based on a relationship between a metric indicated in the LBT diagnostic data as being associated with the at least one of the attempts at random access and a threshold. In some such embodiments, configuring the UE with the adjusted random access resource allocation based on the relationship between the metric and the threshold comprises switching the UE to a 2-step RACH resource allocation responsive to a signal quality metric exceeding a signal quality threshold. In some such embodiments, switching to the 2-step RACH resource allocation is further responsive to a further signal quality metric indicated in the LBT diagnostic data being below a further signal quality threshold. Additionally or alternatively switching to the 2-step RACH resource allocation is further responsive to a number of LBT failures indicated in the LBT diagnostic data exceeding an LBT failure threshold. Additionally or alternatively, switching to the 2-step RACH resource allocation is further responsive to a channel occupancy indicated in the LBT diagnostic data exceeding a channel occupancy threshold. In other embodiments, configuring the UE with the adjusted random access resource allocation based on the relationship between the metric and the threshold comprises switching the UE to a 4-step RACH resource allocation responsive to a signal quality metric being below a signal quality threshold. Additionally or alternatively, the method further comprises adjusting the threshold based on the LBT diagnostic data.

In some embodiments, the method further comprises adjusting a random access message transmission power responsive to receiving the LBT diagnostic data in the report. In some such embodiments, adjusting the random access message transmission power responsive to receiving the LBT diagnostic data in the report comprises adjusting the random access message transmission power responsive to a number of LBT failures indicated in the LBT diagnostic data being above a first LBT failure threshold and below a second LBT failure threshold.

In some embodiments, configuring the UE with the adjusted random access resource allocation based on the LBT diagnostic data of the at least one of the attempts at random access comprises, responsive to receiving the LBT diagnostic data in the report, configuring the UE with both 2-step RACH resources and 4-step RACH resources. In some such embodiments, the method further comprises enabling the UE to autonomously select between using the 2-step RACH resources and the 4-step RACH resources in a subsequent random access attempt based on a signal quality threshold by transmitting the signal quality threshold to the UE responsive to receiving the LBT diagnostic data.

In some embodiments, the method further comprises sending the LBT diagnostic data from a Central Unit Control Plane of the access node to a Distributed Unit of the access node, wherein configuring the UE with the adjusted random access resource allocation based on the LBT diagnostic data of the at least one of the attempts at random access comprises configuring the UE with the adjusted random access resource allocation via the Distributed Unit responsive to the LBT diagnostic data being received at the Distributed Unit.

In some embodiments, the report is a Random Access Report. In other embodiments, the report is a Radio Link Failure Report. In other embodiments, the report is an LBT Report. In other embodiments, the report is a Connection Failure report. In other embodiments, the report is a Secondary Cell Group Failure Report. In other embodiments, the report is a Minimization of Drive Test Report.

In some embodiments, the LBT diagnostic data comprises diagnostic data for at least one attempt at 2-step random access.

In some embodiments, the LBT diagnostic data comprises diagnostic data for at least one attempt at 4-step random access.

In some embodiments, the LBT diagnostic data comprises, for each of the attempts at random access, an amount of time measured by the UE between a first event at the UE with respect to an initial random access message in the attempt, and a second event at the UE. In some such embodiments, the method further comprises for each of the attempts, the first event is a triggering of the UE to perform an LBT procedure in order to transmit the initial random access message. In some such embodiments, for each of the attempts, the second event is one of: a determination by the UE that transmission of the initial random access message, after the LBT procedure, was successful; a switching of BWPs by the UE after failure of the LBT procedure; receipt of a response to the initial random access message after the LBT procedure succeeded; receipt, after transmission of the initial random access message failed, of a response to a further initial random access message transmitted by the UE in a subsequent attempt; and/or expiration of a random access response window timer. Additionally or alternatively, the LBT diagnostic data may further comprise, for at least one of the attempts, a further amount of time that the UE spent waiting for a response to the initial random access message, as measured by the UE.

In some embodiments, the LBT diagnostic data comprises, for at least one of the attempts at random access, an amount of time measured by the UE between a third event at the UE with respect to a message on a Physical Uplink Shared Channel in the attempt, and a fourth event at the UE. In some such embodiments, for each of the at least one of the attempts, the third event is a triggering of the UE to perform an LBT procedure in order to transmit the message on the Physical Uplink Shared Channel. In some such embodiments, for each of the at least one of the attempts, the fourth event is one of: a determination by the UE that transmission of the message on the Physical Uplink Shared Channel, after the LBT procedure, was successful; receipt of a response to the message on the Physical Uplink Shared Channel after the LBT procedure succeeded; or expiration of a random access contention resolution timer. In other embodiments, the LBT diagnostic data further comprises, for at least one of the attempts, a further amount of time that the UE spent waiting for a response to the message on the Physical Uplink Shared Channel, as measured by the UE.

In some embodiments, the LBT diagnostic data comprises, for at least one of the attempts at random access, an amount of time measured by the UE between a triggering of the UE to perform an LBT procedure in order to transmit an initial random access message comprising a contention resolution identity and one of: receipt, by the UE, of a successRAR message comprising the contention resolution identity in response to the initial random access message after the LBT procedure succeeded; receipt, by the UE, of a contention resolution message comprising the contention resolution identity in response to a Physical Uplink Shared Channel transmission made by the UE in the attempt; a reporting, by the UE, of a problem with the attempt; detection, by the UE, that reception of the response to the initial random access message failed; or detection, by the UE, that reception of the response to the Physical Uplink Shared Channel transmission failed.

In some embodiments, the LBT diagnostic data comprises a flag indicating the occurrence of consistent LBT failures at the UE. In other embodiments, the LBT diagnostic data comprises a flag indicating the occurrence of consistent LBT successes at the UE, followed by a random access failure.

Other embodiments include an access node configured to receive, from a user equipment (UE), a report comprising Listen Before Talk (LBT) diagnostic data for each of a plurality of attempts at random access to the access node performed by the UE. The access node is further configured to configure the UE with an adjusted random access resource allocation based on the LBT diagnostic data of at least one of the attempts at random access.

In some embodiments, the access node is further configured to perform any one of the access node methods described above.

In some embodiments, the access node comprises interface circuitry (930) configured for communication in a wireless communication network. The access node further comprises processing circuitry configured to receive, from the UE, the report comprising LBT diagnostic data for each of a plurality of attempts at random access to the access node performed by the UE. The processing circuitry is further configured to configure the UE with an adjusted random access resource allocation based on the LBT diagnostic data of at least one of the attempts at random access. In some such embodiments, the processing circuitry is further configured to perform any one of the access node methods described above.

Other embodiments include a computer program comprising executable instructions that, when executed by processing circuitry in an access node, causes the access node to perform any one of the access node methods recited above.

Other embodiments include a carrier containing the computer program. The carrier is one of an electronic signal, optical signal, radio signal, or computer readable storage medium.

Other embodiments include a communication system including a host computer. The host computer comprises processing circuitry configured to provide user data, and a communication interface configured to forward the user data to a cellular network for transmission to a user equipment (UE). The cellular network comprises a base station having a radio interface and processing circuitry. The base station's processing circuitry is configured to perform any of the steps of the access node described above.

In some embodiments, the communication system further includes the base station.

In some embodiments, the communication system further includes the UE. The UE is configured to communicate with the base station.

In some embodiments, the processing circuitry of the host computer is configured to execute a host application, thereby providing the user data. The UE comprises processing circuitry configured to execute a client application associated with the host application.

Other embodiments include a method implemented in a communication system including a host computer, a base station and a UE. The method comprises, at the host computer, providing user data. The method further comprises, at the host computer, initiating a transmission carrying the user data to the UE via a cellular network comprising the base station. The base station performs any of the steps of the access node described above.

In some embodiments, the method further comprises, at the base station, transmitting the user data.

In some embodiments, the user data is provided at the host computer by executing a host application, and the method further comprises, at the UE, executing a client application associated with the host application.

Other embodiments include a UE configured to communicate with a base station. The UE comprises a radio interface and processing circuitry configured to perform any of the communication system methods described above.

Other embodiments include a communication system including a host computer. The host computer comprises processing circuitry configured to provide user data. The host computer further comprises a communication interface configured to forward user data to a cellular network for transmission to a UE. The UE comprises a radio interface and processing circuitry. The UE's components are configured to perform any of the steps of any of the UE methods described above.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Other embodiments include a method implemented in a communication system including a host computer, a base station and a UE. The method comprises at the host computer, providing user data. The method further comprises, at the host computer, initiating a transmission carrying the user data to the UE via a cellular network comprising the base station. The UE performs any of the steps of any of the UE methods described above.

In some embodiments, the method further comprises, at the UE, receiving the user data from the base station.

Other embodiments include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the UE methods described above.

In some embodiments, the communication system further includes the UE.

In some embodiments, the communication system further includes the base station. The base station comprises a radio interface configured to communicate with the UE and a communication interface configured to forward to the host computer the user data carried by a transmission from the UE to the base station.

In some embodiments, the processing circuitry of the host computer is configured to execute a host application. The UE's processing circuitry is configured to execute a client application associated with the host application, thereby providing the user data.

In some embodiments, the processing circuitry of the host computer is configured to execute a host application, thereby providing request data. The UE's processing circuitry is configured to execute a client application associated with the host application, thereby providing the user data in response to the request data.

Other embodiments include a method implemented in a communication system including a host computer, a base station and a UE. The method comprises, at the host computer, receiving user data transmitted to the base station from the UE. The UE performs any of the steps of any of the UE methods described above.

In some embodiments, the method further comprises, at the UE, providing the user data to the base station.

In some embodiments, the method further comprises, at the UE, executing a client application, thereby providing the user data to be transmitted. The method further comprises, at the host computer, executing a host application associated with the client application.

In some embodiments, the method further comprises at the UE, executing a client application. The method further comprises, at the UE, receiving input data to the client application. The input data is provided at the host computer by executing a host application associated with the client application. The user data to be transmitted is provided by the client application in response to the input data.

Other embodiments include a communication system including a host computer comprising a communication interface configured to receive user data originating from a transmission from a UE to a base station. The base station comprises a radio interface and processing circuitry. The base station's processing circuitry is configured to perform any of the steps of any of the access node methods described above.

In some embodiments, the communication system further includes the base station.

In some embodiments, the communication system further includes the UE. The UE is configured to communicate with the base station.

In some embodiments, the processing circuitry of the host computer is configured to execute a host application. The UE is configured to execute a client application associated with the host application, thereby providing the user data to be received by the host computer.

Other embodiments include a communication system including a host computer, a base station and a UE. The method comprises, at the host computer, receiving, from the base station, user data originating from a transmission which the base station has received from the UE. The UE performs any of the steps of any of the UE methods described above.

In some embodiments, the method further comprises, at the base station, receiving the user data from the UE.

In some embodiments, the method further comprises, at the base station, initiating a transmission of the received user data to the host computer.

Other embodiments will be appreciated in view of the detailed discussion below.

### BRIEF DESCRIPTION OF THE DRAWINGS

FIG. 1A is a signaling diagram of a traditional 4-step random access procedure.

FIG. 1B is a signaling diagram of a traditional 2-step random access procedure.

FIGS. 2A and 2B include ASN.1 code of conventional RRC signaling relating the random access reporting.

FIG. 3 is a block diagram illustrating a traditional 5G RAN architecture.

FIG. 4 is a block diagram illustrating a conventional split-stack 5G RAN architecture.

FIG. 5 is a schematic illustrating an example communication system, according to one or more embodiments of the present disclosure.

FIG. 6 is a schematic illustrating an example time-frequency resource grid used in a wireless communication network, according to one or more embodiments of the present disclosure.

FIG. 7 is a schematic illustrating an example radio frame, according to one or more embodiments of the present disclosure.

FIG. 8 is a flow diagram illustrating an example method performed by a UE, according to one or more embodiments of the present disclosure.

FIG. 9 is a flow diagram illustrating an example method performed by a network node, according to one or more embodiments of the present disclosure.

FIGS. 10A, 10B, 11A, and 11B include ASN.1 code of RRC signaling in accordance with a first example signaling embodiment of the present disclosure.

FIGS. 12, 13A, 13B, and 13C include ASN.1 code of RRC signaling in accordance with a second example signaling embodiment of the present disclosure.

FIGS. 14A, 14B, and 15 include ASN.1 code of RRC signaling in accordance with a third example signaling embodiment of the present disclosure.

FIG. 16 is a schematic block diagram illustrating an example UE, according to one or more embodiments of the present disclosure.

FIG. 17 is a schematic block diagram illustrating an example network node, according to one or more embodiments of the present disclosure.

FIG. 18 illustrates an example wireless network, according to one or more embodiments of the present disclosure.

FIG. 19 illustrates an example UE, according to one or more embodiments of the present disclosure.

FIG. 20 illustrates an example virtualization environment, according to one or more embodiments of the present disclosure.

FIG. 21 illustrates an example telecommunication network connected via an intermediate network to a host computer, according to one or more embodiments of the present disclosure.

FIG. 22 illustrates an example host computer communicating via a base station with a user equipment over a partially wireless connection, according to one or more embodiments of the present disclosure.

FIGS. 23-25 illustrate example methods implemented in a communication system, according to one or more embodiments of the present disclosure.

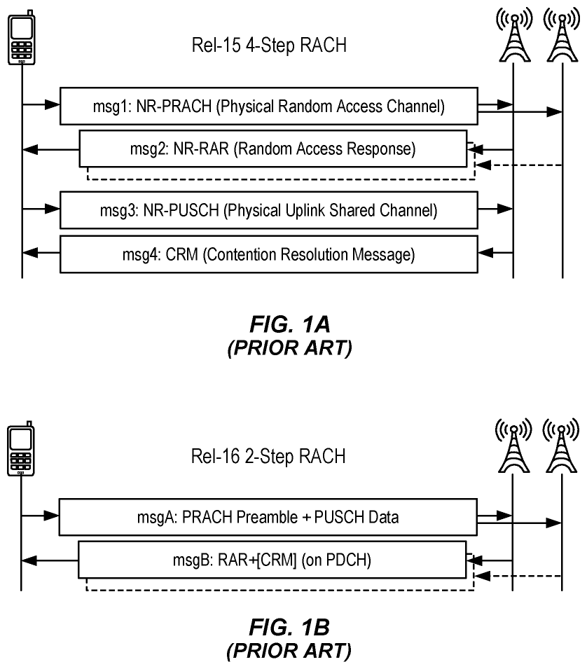

### DETAILED DESCRIPTION

Current MDT/SON reporting (e.g., failure reports, optimization reports) does not take into account possible LBT failures that may affect the UE which are neither related the random access procedure (2-step, 4-step) nor related to other uplink transmissions. In fact, from the network perspective, it is not possible to know whether a given uplink message was not received because of an LBT failure (i.e., in which the UE did not transmit an uplink message at all), or because of a decoding issue at the gNB side (e.g., the UE did transmit an uplink message, but inadequate energy was detected by the gNB, possibly because transmission power at the UE was too low). Additionally, in licensed communication, a random access procedure may either succeed or result in RLF/handover/connection setup or resume failure (depending what had triggered the random access procedure). On the other hand, in unlicensed communication, the random access procedure may fail because of consistent LBT failure, without the UE necessarily declaring RLF and triggering a reestablishment or SCG failure reporting procedure (i.e., upon consistent LBT failures in the Special Cell (SpCell) (i.e., a PCell or a PSCell) the UE initiates random access in another BWP in the same cell).

The lack of this diagnostic data, especially related to random access, may result in poor network knowledge about interference scenarios that may lead to a poor 4-step and/or 2-step random access resource allocation. This may ultimately result in lower connection establishment success for the UE.

In view of the above, according to one or more embodiments of the present disclosure, the UE logs and reports, to the network, diagnostic data associated with the random access procedure (e.g., whether 2-step random access is performed, whether 4-step random access is performed, whether both are performed) in the particular case of random access being performed in the unlicensed spectrum. Ways in which the logged diagnostic information may be used to advantageously optimize or enhance the network configuration are described below. In general, one or more embodiments of the present disclosure additionally or alternatively relate generally to QoS-based triggering of RLF.

More particularly, one or more embodiments of the present disclosure enable the network to detect problems related to the random access procedure when performed in the unlicensed spectrum. By knowing the random access performances, the network may, for example, rearrange the resources allocated to random access. In one particular example, in response to persistent LBT failures being detected, resources may be reallocated in order to avoid interferers operating in the same spectrum. Additionally or alternatively, the network may readjust the power ramping performed in response to LBT failures that occasionally occur in the msg1 and which cause the UE to report random access failures, e.g. ra-ResponseWindow or msgB-ResponseWindow expiring without any msg2/msgB received.

Additionally or alternatively, the network may use such information to determine whether 2-step RACH or 4-step RACH is preferable given an experienced interference scenario, e.g., to tune the RSRP, Received Signal Strength Indicator (RSSI), and/or channel occupancy thresholds for selecting between using 2-step RACH or 4-step RACH. Finally, the input of the proposed MDT reports can trigger a SON algorithm which could be used to coordinate the RACH resources with other Public Land Mobile Networks (PLM Ns) operating in the same frequency.

Similarly, if failures occur after msg1 transmission, the network may use information in the RACH report to properly schedule the msgB/msg2/msg4, e.g., to avoid interference from a hidden node, and/or to provide an efficient resource allocation for the msg3 transmission.

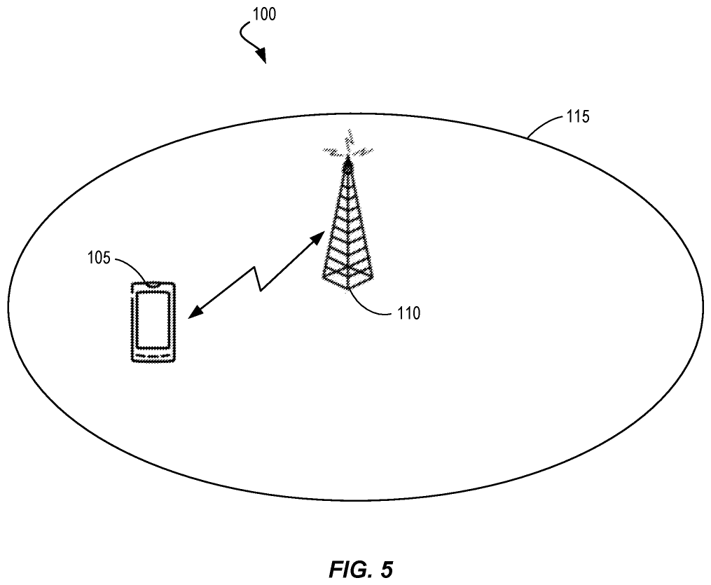

FIG. 5 illustrates an example communication system 100 according to one or more embodiments of the present disclosure. Although certain aspects of the communication system 100 may herein be described in the context of an LTE, 5G, and/or NR communication network, the discussion throughout this disclosure may similarly be applied to any of these wireless communication systems, other wireless communication systems (e.g., Wi-Fi), and/or combinations thereof.

The communication system 100 comprises a plurality of wireless communication nodes. One of the wireless communication nodes in particular is an access node 110 that serves a cell 115 to a UE 105. The UE 105 and/or access node 110 may, e.g., each be referred to as a radio node (i.e., a network node capable of radio communication). Further, the access node 110 may be referred to, in some embodiments, as a base station, an eNB, or an gNB (among other things, depending on the particular embodiment). Although only one access node 110 and one UE 105 are illustrated in FIG. 5, other examples of the communication system 100 may include any number of access nodes 110, each of which may serve one or more cells 115 or beams (not shown) to any number of UEs 105. Further, according to other embodiments, the UE 105 may, instead, be a base station (e.g., a femtocell, relay base station).

As discussed above, in order for the UE 105 to access communication system 100, the the UE 105 may instigate a random access procedure with the access node 110. Further, before either the UE 105 or access node 110 transmits on unlicensed or shared spectrum, each may be required to perform an LBT procedure.

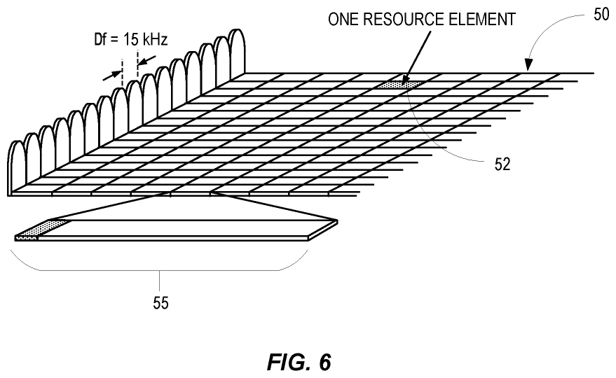

Wireless communication between the access node 110 and one or more UEs 105 is performed using radio resources across a time domain, a frequency domain, or both. LTE and NR in particular use Orthogonal Frequency Division Multiplexing (OFDM) in the downlink. The basic NR or LTE downlink physical resource may be viewed as a time-frequency grid, as illustrated in FIG. 6.

FIG. 6 illustrates a portion of an example OFDM time-frequency grid 50, e.g., for LTE and/or NR. Generally speaking, the time-frequency grid 50 is divided into subframes, as will be discussed below. Each subframe includes a plurality of OFDM symbols 55. Each symbol 55 may include a cyclic prefix. The cyclic prefix may be longer or shorter based on conditions. For example, a normal cyclic prefix (CP) length may be used in situations in which multipath dispersion is not expected to be severe. Alternatively, an extended cyclic prefix may be used in situations in which multipath dispersion is expected to be severe. In general, a subframe may comprise fewer symbols 55 when longer cyclic prefixes are used, and more symbols 55 when shorter cyclic prefixes are used.

According to the present example, the physical resources shown in FIG. 6 are divided across the frequency domain into adjacent subcarriers with a spacing of 15 kHz. Other embodiments may include other spacing (i.e., different in the time domain, in the frequency domain, or both). In particular, the number of subcarriers may, in some embodiments, vary according to the allocated system bandwidth. The smallest element of the time-frequency grid 50 is typically referred to as a resource element 52, which comprises one OFDM subcarrier during one OFDM symbol interval.

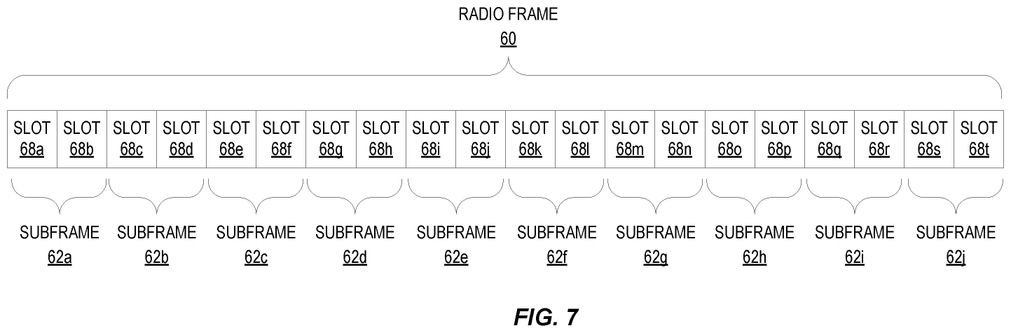

Data is transmitted from the access node 110 to the UE 105 over a downlink transport channel. The downlink transport channel is a time and frequency multiplexed channel shared by a plurality of UEs 105. The downlink transmissions are typically organized into radio frames of a given duration (e.g., ten milliseconds). Each radio frame may comprise a plurality of subframes 62. According to one example, a radio frame 60 may comprise ten equally-sized subframes 62a-j, as shown in FIG. 7. Each subframe 62 may comprise one or more slots 68. For example, as shown in FIG. 7, a subframe 62a may comprise two equally-sized slots 68a-b. In particular, FIG. 7 illustrates an example in which the radio frame 60 comprises twenty equally-sized slots 68a-t.

According to embodiments, a slot 68 may comprise a plurality of symbols 55, the precise number of which may vary according to the embodiment. For example, a slot 68 may comprise seven or fourteen symbols 55, according to particular embodiments. Further, in some embodiments, the slot duration may be configurable, such that the number of symbols 55 in a slot 68 may, e.g., be set in the UE 105 by the access node 110. Further still, a plurality of symbols 55 fewer than the number of symbols in a slot 68 may be referred to, in some embodiments, as a mini-slot (not shown).

PDCCHs may be used, e.g., in NR for downlink control information (DCI). This DCI may, e.g., include downlink scheduling assignments and uplink scheduling grants. The PDCCHs are traditionally transmitted at the beginning of a slot 68 (e.g., in an area of the grid identified as a CORESET) and relate to data in the same or a later slot. For mini-slots, a PDCCH may also be transmitted within a regular slot. Different formats (e.g., sizes) of the PDCCHs are possible to handle different DCI payload sizes and different aggregation levels (i.e. a given code rate for a given payload size).

According to embodiments of the present disclosure, diagnostic information about random access performed in an unlicensed spectrum is reported to the access node 110 (e.g., gNB). Such information may be reported separately for 2-step and 4-step RACH. As will be described in further detail below, the 2-step/4-step RACH report may, in turn, be included in an overall RACH report, in an RLF report, in an SCG failure report (if RACH failed in a cell of the secondary cell group), in an LBT report, as part of accessibility measurement, and/or as part of a connection failure report.

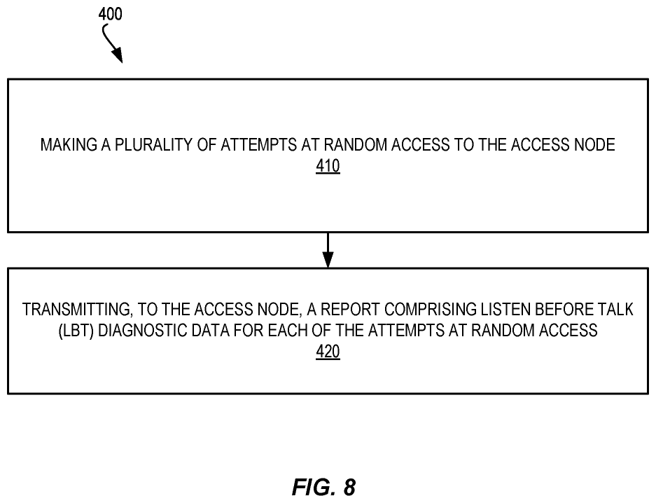

Particular embodiments include a method (400) performed by a UE (105), as shown in FIG. 8. The method (400) comprises making a plurality of attempts at random access to the access node (110) (step 410). The method (400) further comprises transmitting, to the access node (110), a report comprising Listen Before Talk (LBT) diagnostic data for each of the attempts at random access (step 420).

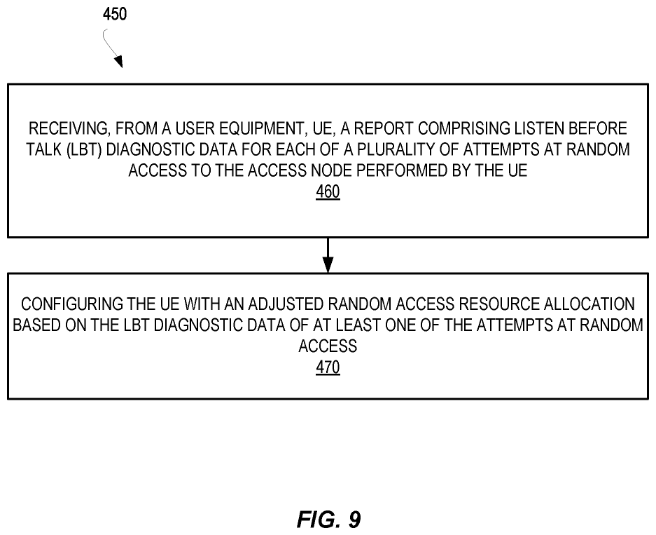

Other embodiments include a method (450) performed by an access node (110), as shown in FIG. 9. The method (450) comprises receiving, from a UE (105), a report comprising Listen Before Talk (LBT) diagnostic data for each of a plurality of attempts at random access to the access node (110) performed by the UE (105) (step 460). The method (450) further comprises configuring the UE (105) with an adjusted random access resource allocation based on the LBT diagnostic data of at least one of the attempts at random access (step 470).

For each initiated random access procedure, the diagnostic data reported to the access node 110 may contain a variety of information related to random access performance. Such information may include, for example, whether LBT was successful or not for a given preamble transmission (e.g., a msgA or msg1 transmission) or a msg3 transmission (when 4-step RACH or 2-step RACH with a fallback to 4-step RACH is performed). Such information may additionally or alternatively include the cumulative number of LBT failures experienced during the random access procedure (e.g., considering LBT failures that occur during both msg1 and msg3 transmission). Such information may additionally or alternatively include LBT configuration information used during the random access procedure.

The diagnostic information reported to the access node 110 about random access may additionally or alternatively include the amount of time spent by the UE 105 before it was able to successfully transmit one preamble (msgA/msg1) or the msg3 (when 4-step RACH or 2-stepRACH with fallback to 4-step RACH is performed). For example, in some embodiments, a timer is started for msgA/msg1 when the physical layer triggers a preamble transmission, and the timer is stopped when LBT for the preamble transmission is successful. This process may be performed by the UE 105 for each preamble transmission attempt. In some embodiments, when an LBT failure on that BWP in which the UE 105 did not receive an opportunity to transmit the preamble, the timer is stopped when the UE 105 performs BWP switching. In some embodiments, the timer is stopped when msgB/msg2 is correctly received by the UE, which means that the timer is not restarted when the RARwindow expires. Rather, the UE 105 also keeps the timer running when another preamble is selected and until a msgB/msg2 is received. In yet other embodiments, the timer is stopped when the Random Access Response (RAR) window timer expires.

In some embodiments, the timer is started for msg3 when a MAC PDU containing the msg3 is sent to the physical layer for transmission, and it is stopped when LBT for the msg3 transmission is successful. In some embodiments, the timer is stopped when msg4 is correctly received by the UE 105, or when the RA contention resolution timer expires.

In yet further embodiments, the UE 105 may separately indicate the time spent waiting for reception of msg2 and msg4. This information can be useful because it considers possible LBT failures on the access node 110 side in transmitting the msg2/msg4, as well as possible decoding issues on the UE 105 side due to nodes that are hidden from the UE 105 yet also communicating with the access node 110 (e.g., the access node 110 may be a serving gNB for both the UE 105 and one or more other nodes that the UE 105 cannot detect).

The diagnostic information reported to the access node 110 about random access may additionally or alternatively include the cumulative time spent by the UE 105 before successfully completing the random access procedure. In some such embodiments, a timer is started when the physical layer triggers a preamble transmission for the first RA attempt, and the timer is stopped upon successful reception of, in the case of 2-step RACH, a msgB is received that comprises a successRAR indication and a UE Contention resolution identity matching the UE identity provided in msgA. In the case of 4-step RACH (or 2-step RACH with 4-step RACH fallback), the timer is stopped upon successful reception of a msg4 comprising a UE Contention resolution identity that matches the UE identity provided by the UE 105 in msg3.

In some such embodiments, responsive to an RLF, handover failure, or connection failure report being triggered, this cumulative time indicates the time spent from when the random access procedure was initiated by the UE (i.e., a msg1/msgA transmission attempt triggered by physical layer) until random access problems are reported to higher layers (i.e., the RLF, handover failure, or connection failure report issued) or until a connection is successfully established.

The diagnostic information reported to the access node 110 about random access may additionally or alternatively include a consistent LBT failure flag, which may (for example) be included in the “cause” field of a RACH, RLF, LBT, SCG, and/or connection failure report to indicate that the associated random access procedure was not initiated due to consistent LBT failures. The consistent LBT failure flag may be included additionally or alternatively as part of the RACH, RLF, LBT, SCG, and/or connection failure report to indicate that while performing the associated random access procedure the UE 105 experienced consistent LBT failure.

The diagnostic information reported to the access node 110 about random access may additionally or alternatively include a flag indicating consistent LBT success followed by RACH failure, which may be included in the “cause” field of the RACH, RLF, LBT, SCG, and/or connection failure report to indicate that random access procedure failure was not due to consistent LBT failure.

The diagnostic information reported to the access node 110 about random access may additionally or alternatively include the time spent by the UE 105 in failed RA attempts. In some such embodiments in which 4-step RACH is performed, a timer is started when the physical layer triggers a preamble transmission, and it is stopped after failing to receive msg2 and/or msg4, in which case the time reported indicates the cumulative time spent by the UE 105 during a failed RA attempt with 4-step RACH, including LBT. In other such embodiments in which 2-step RACH is performed, a timer is started when the physical layer triggers a preamble transmission, and it is stopped after failing to receive msgB, in which case the time reported indicates the cumulative time spent by the UE 105 during a failed RA attempt with 2-step RACH, including LBT.

The diagnostic information reported to the access node 110 about random access may additionally or alternatively include other information not directly associated to LBT failures, such as information related to the BWP selected by the UE 105 in which to perform RA (e.g., location and bandwidth, subcarrier spacing, Absolute Radio-Frequency Channel Number (ARFCN) value associated with the selected BWP).

The diagnostic information reported to the access node 110 about random access may additionally or alternatively include a list of PLMNs or other stations (e.g., WLAN stations) that the UE 105 detected as operating in the same frequency in which the random access procedure was initiated.

The diagnostic information reported to the access node 110 about random access may additionally or alternatively include the msgA/msg3 buffer status, representing the data to be transmitted as part of msgA/msg3 (e.g., either at the moment in which the random access procedure was initiated or at the moment in which the first preamble associated to a random access procedure, or any preamble associated to a random access procedure, is successfully transmitted, i.e. upon LBT success).

The diagnostic information reported to the access node 110 about random access may additionally or alternatively include a fallback flag indicating whether a fallback from a 2-step RACH procedure to a 4-step RACH procedure occurred.

The diagnostic information reported to the access node 110 about random access may additionally or alternatively include switch information indicating whether a 2-step RACH procedure was switched to 4-step RACH (i.e., not to be confused with a fallback to 4-step RACH, as discussed above). In some embodiments, the switch information is signaled through a “switch” flag in the 2-step RACH report. In other embodiments, the switch information is implicitly signaled by the UE 105 including in the RACH, RLF, LBT, SCG, and/or connection failure report both a 2-step RACH report and a 4-step RACH report (i.e., the existence of both RACH reports implies that a switch was performed in some embodiments).

The diagnostic information reported to the access node 110 about random access may additionally or alternatively include an RSSI and/or channel occupancy measured by the UE 105 in the cell 115 in which the random access procedure was executed. The diagnostic information reported to the access node 110 about random access may additionally or alternatively include the MOOT as configured in the UE 105. Though this is a network configuration parameter itself, having it in the report sent by the UE 105 may help the network to identify what values were configured for this UE at the time when the UE attempted to perform RA procedure (e.g., given that the report may be sent by the UE at a much later point in time).

The diagnostic information reported to the access node 110 about random access may additionally or alternatively include beam-specific information associated with each LBT attempt. For example, the UE can log beam-specific information for each selected beam when an LBT attempt is performed, e.g., in case beam selection is not successful. For example, a UE 105 in a given cell (e.g., cell A) may select a first beam (e.g., beam 5), and in response to an LBT failure on that first beam may select a second beam (e.g., beam 2), where the LBT procedure succeeds. By logging and reporting that information, the network may be made aware that LBT has failed in a particular beam of a particular cell (i.e., beam-2 of cell-A, in this example). A beam in this context can be identified by a reference signal transmitted in a beam such as a Synchronization Signal/Physical Broadcast Channel Block (SS/PBCH Block, also called an SSB) or a CSI-RS resource. The beam-specific information for a selected beam may comprise, for example, a beam index (e.g. an SSB index, CSI-RS identifier), beam measurement results, an indication of whether or not a selected beam had an LBT failure, and/or a flag indicating whether the RSRP measurement value of the selected beam is above the 2-step RACH selection threshold. The beam measurement results may, for example, include an RSRP per beam, a Reference Signal Received Quality (RSRQ) per beam, and/or a Signal-to-Interference-plus-Noise Ratio (SINR) per beam.

According to various embodiments, a new 2-step RACH report may be appended in a UE assistance information report (such as a logged MDT, RACH report, connection establishment report, RLF report, and/or handover failure report) in response to one more events. In some such embodiments, the new 2-step RACH report is provided in response to the UE 105 selecting a new 2-step RACH resource in a cell 115 as a result of a downlink signal quality (e.g., RSRP, RSSI) being above a configurable threshold in the concerned cell, and/or channel occupancy above a certain threshold. Additionally or alternatively, the new 2-step RACH report is provided in response to the UE 105 selecting a new BWP in the same cell for 2-step RACH as a result of consistent LBT failures during a random access procedure in an SpCell.

A new 4-step RACH report may additionally or alternatively be appended in a UE assistance information report (such as logged MDT, RACH report, connection establishment report, RLF report, handover failure report) in response to one or more events. In some such embodiments, the new 4-step RACH report is provided in response to the UE selecting a new 4-step RACH resource in a cell 115. Additionally or alternatively, the new 4-step RACH report is provided in response to the UE selecting a new BWP in the same cell for 4-step RACH as a result of consistent LBT failures during a random access procedure in an SpCell. Additionally or alternatively, the new 4-step RACH report is provided in response to the UE selecting a new 4-step RACH resource as a result of 2-step RACH being switched to 4-step RACH upon reaching a maximum of 2-step RACH preamble transmission attempts and experiencing consistent LBT failure during a random access procedure in an SpCell.

UE may additionally log the event that caused each 2/4 step RACH report procedure listed above. The 2-step/4-step RACH reports discussed above may be included within a larger container (e.g., a larger report). Such a container may include, for example, an overall RACH report for a given random access procedure. In some such embodiments, the RACH report is appended to the signal reported to the access node 110 for a random access procedure only in response to the random access procedure being successful (e.g., after successful contention resolution). Additionally or alternatively, the RACH report may be appended to the signal reported to the access node 110 in response to the UE 105 experiencing consistent LBT failures in a SpCell while performing the random access procedure and/or in response to the UE triggering consistent LBT failures during normal operations (i.e., during operations that are not part of the random access procedure).

Such a container may additionally or alternatively include, for example, an RLF report that is appended to the signal reported to the access node 110 in response to RLF being triggered upon the UE 105 declaring consistent LBT failures in all BWPs.

Such a container may additionally or alternatively include, for example, an LBT report (details of the signaling of which are described below) that is appended to the signal reported to the access node 110 in response to one or more messages to be transmitted during a random access procedure being affected by LBT failures (e.g. at least one msg1/msgA/msg3 transmission had to be postponed due to LBT failures), the amount of LBT failures experienced during a random access procedure is above a certain threshold, and/or the UE declares consistent LBT failure in one or more BWPs of a serving cell, upon which event the UE 105 may switch the BWP of the SpCell or stop uplink communication in the affected SCell. The LBT failure information may be transmitted as part of accessibility measurement (e.g., in a connection establishment failure report when the UE 105 makes a transition from RRC IDLE/INACTIVE to RRC_CONNECTED mode), and/or a handover failure report.

Such a container may additionally or alternatively include, for example, a connection establishment failure report which may include a random access report indicating the RACH attempts that experienced LBT failures.

Such a container may additionally or alternatively include, for example, an SCG failure report, which is appended to the signal reported to the access node 110 in response to physical layers triggering SCG failure due to random access failures in a cell belonging to the SCG. The particular signaling used in one or more of the embodiments described herein may take a variety of different forms. Although the present disclosure will list three particularly concrete example signaling embodiments, aspects from each may be combined or used separately depending on the particular implementation.

According to a first signaling embodiment, two separate 2-step/4-step RACH info report Information Elements (IEs) are determined, each comprising statistics for 2-step and 4-step RACH, respectively. Such 2-step/4-step IEs may be included within an RA-report, RLF report, LBT report, SCG failure report, and/or connection failure report. If any such report includes both the 2-step and the 4-step RACH information, this indicates that 2-step RACH was switched to 4-step RACH.

In particular, according to this first signaling embodiment, for each RA attempt, the UE 105 indicates whether or not LBT was successful for the corresponding preamble (or msg3) transmission, e.g., for each transmission attempt of the preambles listed in the perRAAttemptInfoList, information about LBT is included. If the preamble transmission/msg3 transmission was successful with LBT, the UE also indicates the time elapsed between when the corresponding msg1/msgA/msg3 was submitted to lower layers for transmission until either the msg1/msgA/msg3 is successfully transmitted (i.e. an LBT successful result is achieved) or an RLF event or LBT consistent failures event is triggered.

Responsive to the preamble transmission being successful, the UE 105 may also indicate whether the corresponding expected RAR message (i.e., msg2/msgB) was received, and for how long the UE 105 had to wait. Responsive to no RAR being received within the RAR window, the UE 105 may set this value to “inf” or simply indicate that a RAR was not detected. Similarly, for msg3 reception, the UE 105 may indicate the time the UE 105 waited until reception of the msg4, i.e., contention resolution message. Additionally or alternatively, the UE 105 may indicate if fallBackRAR or successRAR is received for the corresponding preamble transmission. The UE 105 may additionally or alternatively indicate the absolute RSSI and/or channel occupancy or whether the RSSI and/or channel occupancy is (or are) below or above a given threshold as measured when the msg1/msgA transmission is attempted.

Note that some of such mentioned parameters may be included directly as part of an RA-report, RLF report, or LBT report. In such embodiments, the RSSI/channel occupancy may, for example, represent the average RSSI/channel occupancy measured during the corresponding random access procedure until successful completion, until RLF is triggered, or until consistent LBT failure is triggered.

The RA/RLF/LBT report may additionally or alternatively comprise the overall time the UE 105 needed to complete the RA procedure, or the time from the moment in which msg1/msgA was submitted to lower layers for transmission until the RLF/LBT report was triggered, or until the random access completed (i.e., a contention resolution message was received), or until the RLF/“LBT consistent failure” triggered.

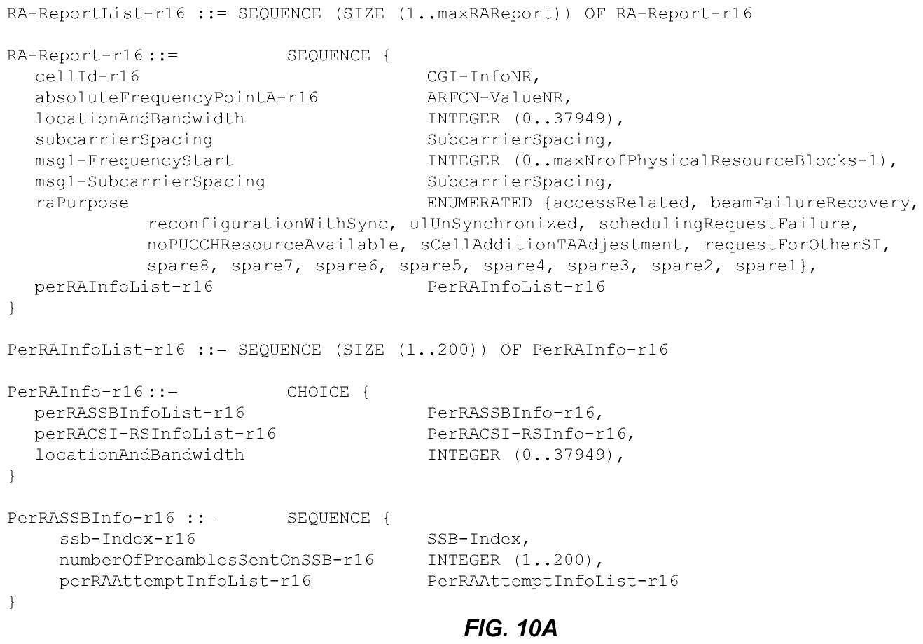

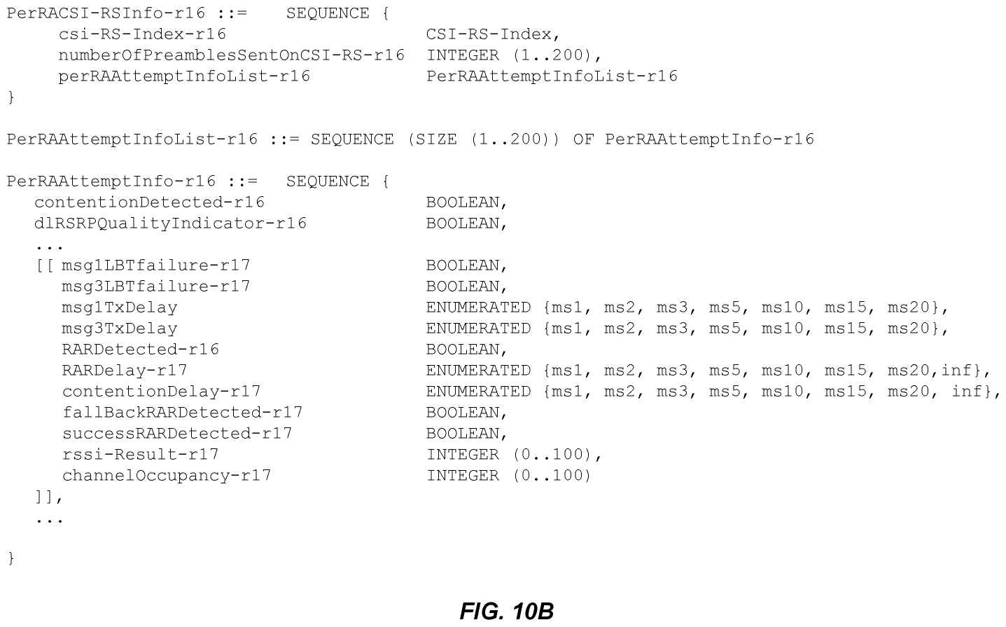

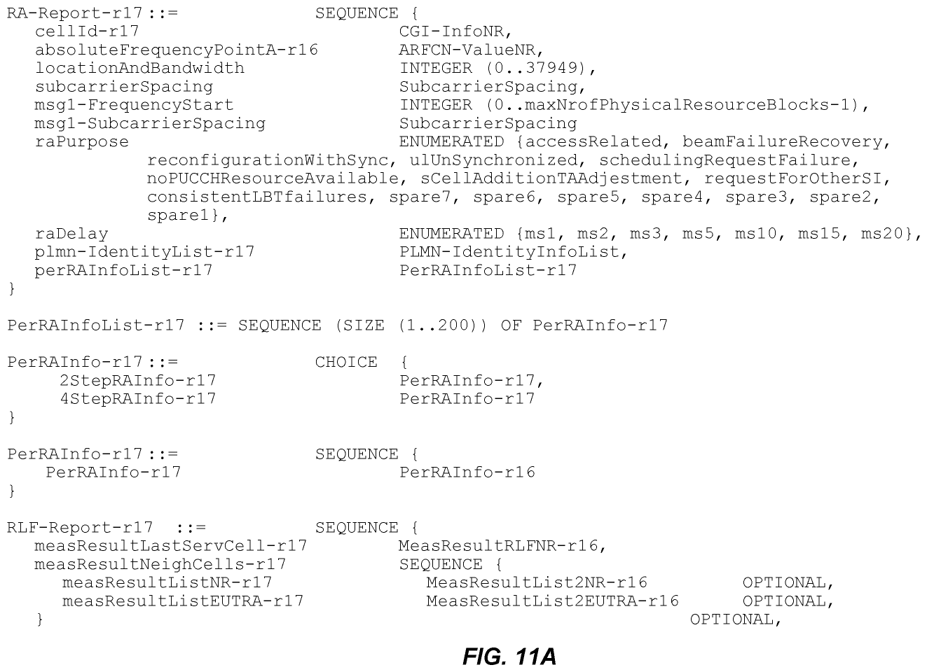

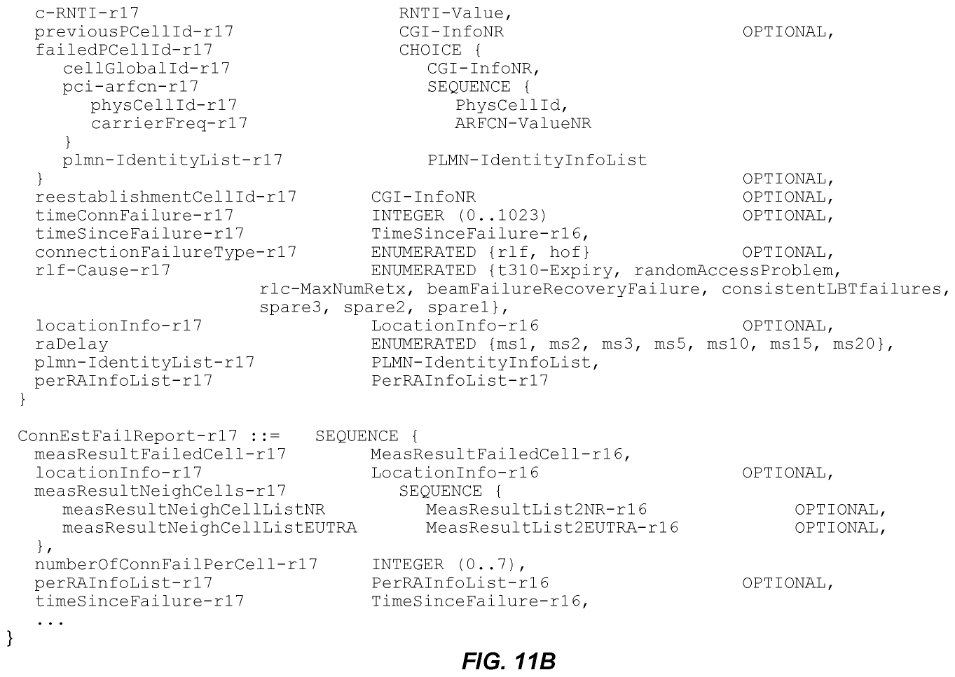

FIGS. 10A, 10B, 11A, and 11B illustrate example ASN.1 signaling definitions that are usable together and are consistent with examples of the first signaling embodiment discussed above. In FIGS. 10A and 10B, the definition of certain traditional IEs are modified to incorporate additional information as discussed above. Of particular note, an extension addition group is added to the ASN.1 definition of the PerRAAttemptInfo-r16 IE (as denoted by the double square brackets). The extension addition group includes various items to indicate whether or not LBT failure was experienced with respect to certain RA messages, to reflect amounts of transmission or reception delay experienced, to indicate whether or not fallback occurred, to indicate whether or not a RAR was detected, and to indicate certain signal quality and channel occupancy results, consistent with the discussion above. Other embodiments may include additional, fewer, or different items, depending on the implementation.

In FIGS. 11A and 11B, examples of new IEs are shown that define signaling useful for reporting RA information to the network (e.g., using a new RA-Report data structure) in a manner consistent with the first signaling embodiment described above. The differences in signaling between, e.g., the RA-Report-r16 IE and the new RA-Report-r17 IE can be appreciated by comparing the ASN.1 of FIGS. 10A and 10B against that of FIGS. 11A and 11B. Although several differences are present, one such difference that may be of particular note is that a 2StepRAInfo-r17 IE and a 4StepRAInfo-r17 IE are provided in a CHOICE block, such that each PerRAInfo-r17 item in the PerRAInfoList-r17 can provide either 2-step RACH or 4-step RACH information, as discussed above.

According to a second signaling embodiment, one or more of the statistics discussed above may be included in an LBTInfo IE to be included in the RA/RLF report or accessibility measurement (e.g., a Connection Establishment Failure Report when the UE 105 performs a transition from RRC idle/inactive to RRC connected mode). Such an LBTInfo IE, in turn, may contain two separate information lists, one of which is related to 2-step RACH attempts, and another of which is related to 4-step RACH attempts. Alternatively, separate LBTInfo IEs can be reported for the 2-step RACH and 4-step RACH. Each of the 2/4-step attempts reported in these lists point (e.g. through an index) to a specific random access procedure included in the RA/RLF report for which LBT failures occurred and also points to one or more preamble transmission attempts corresponding to this random access procedure.

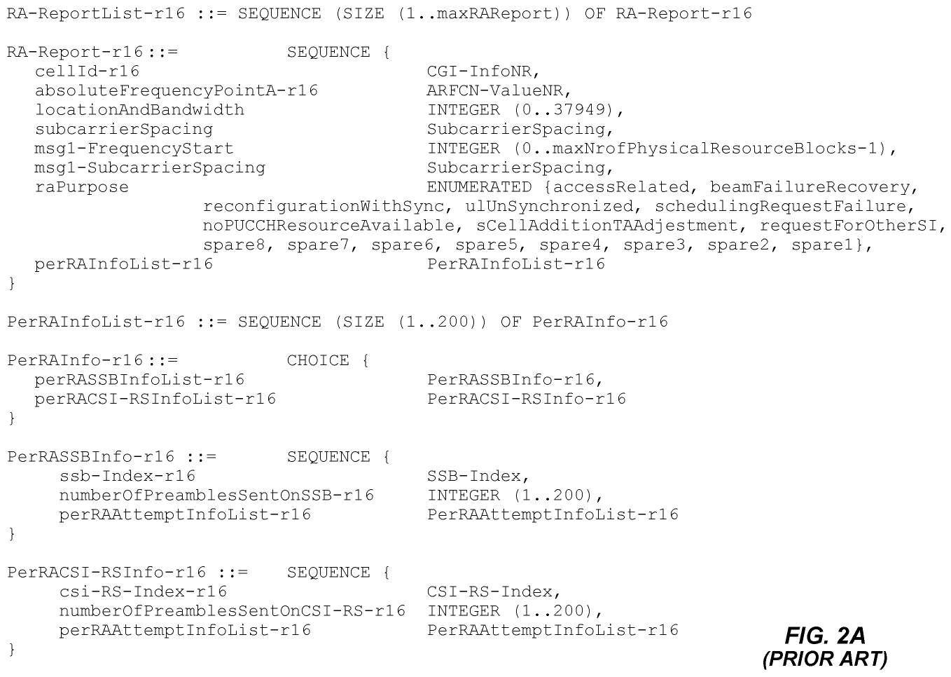

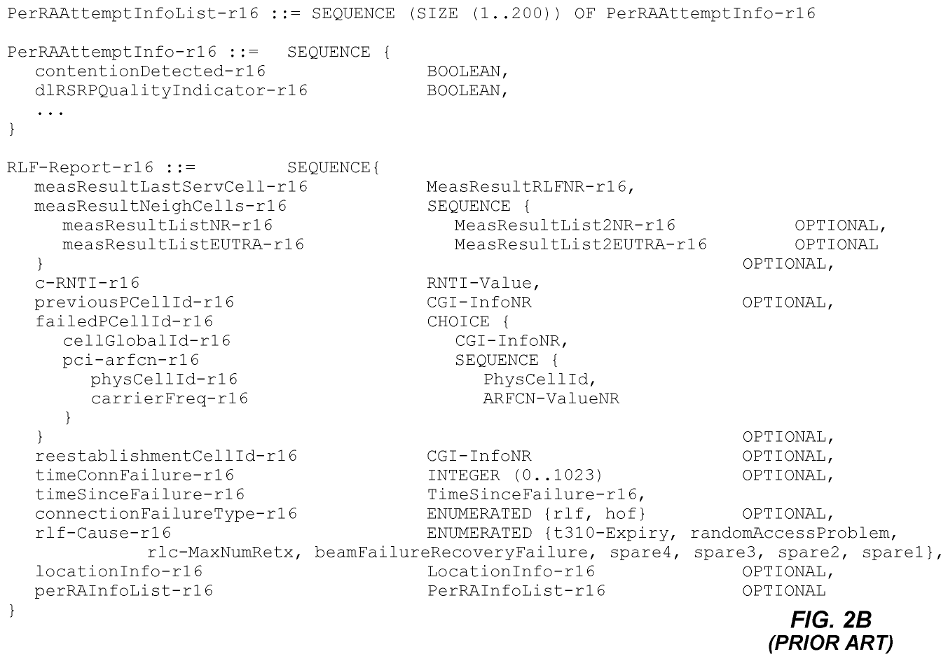

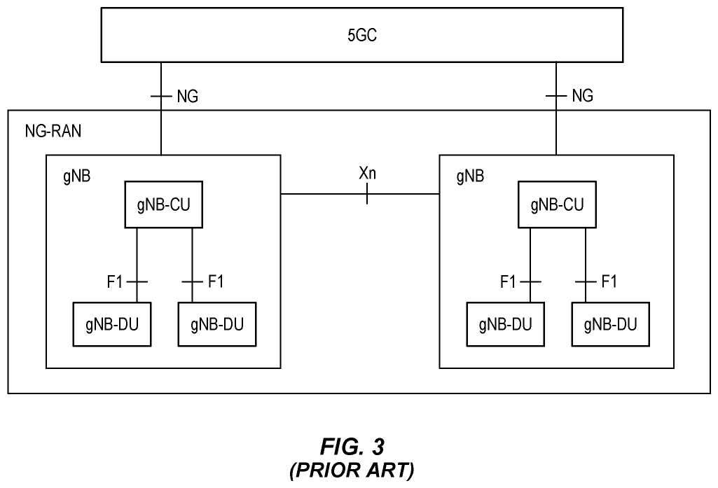

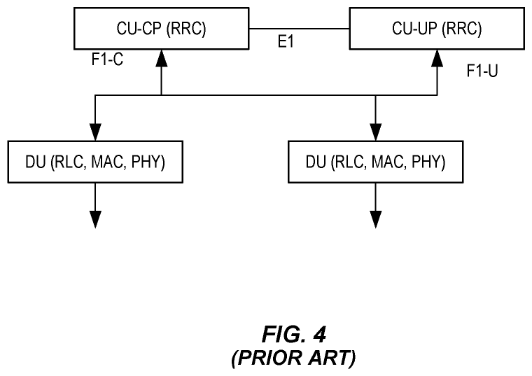

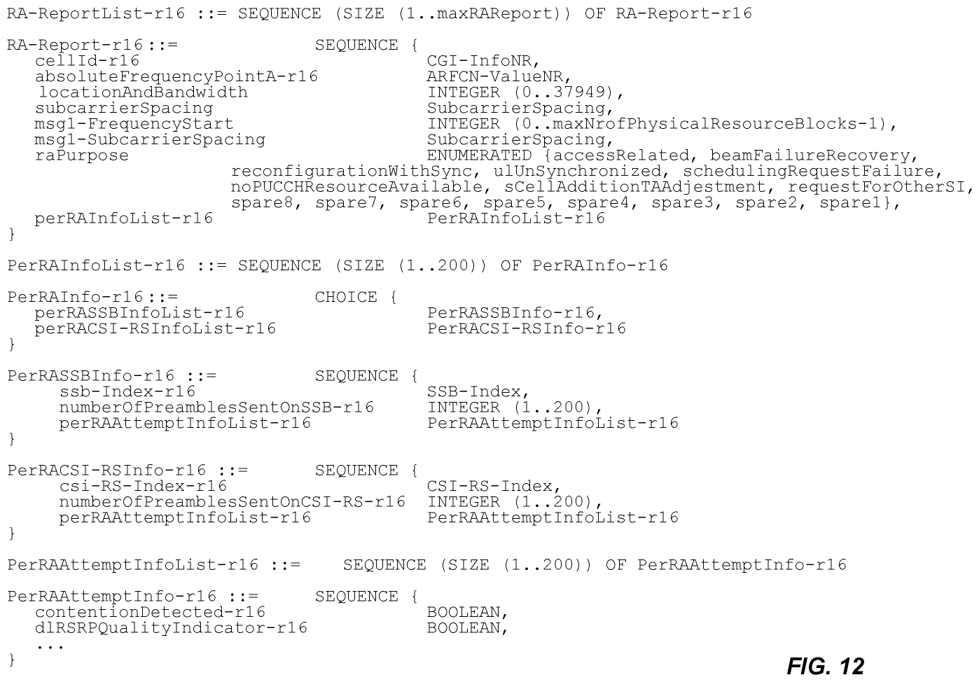

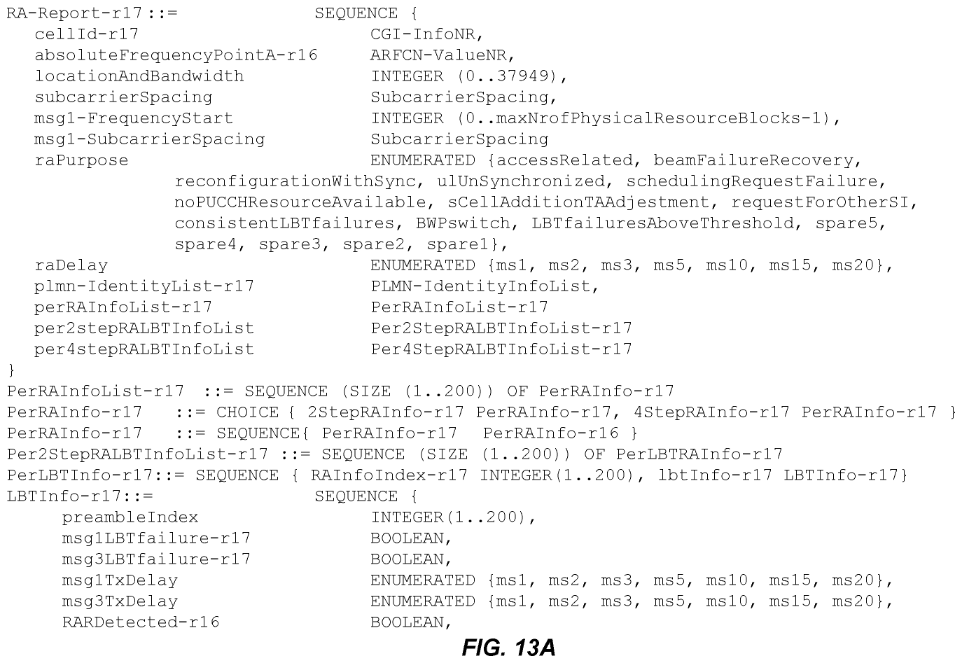

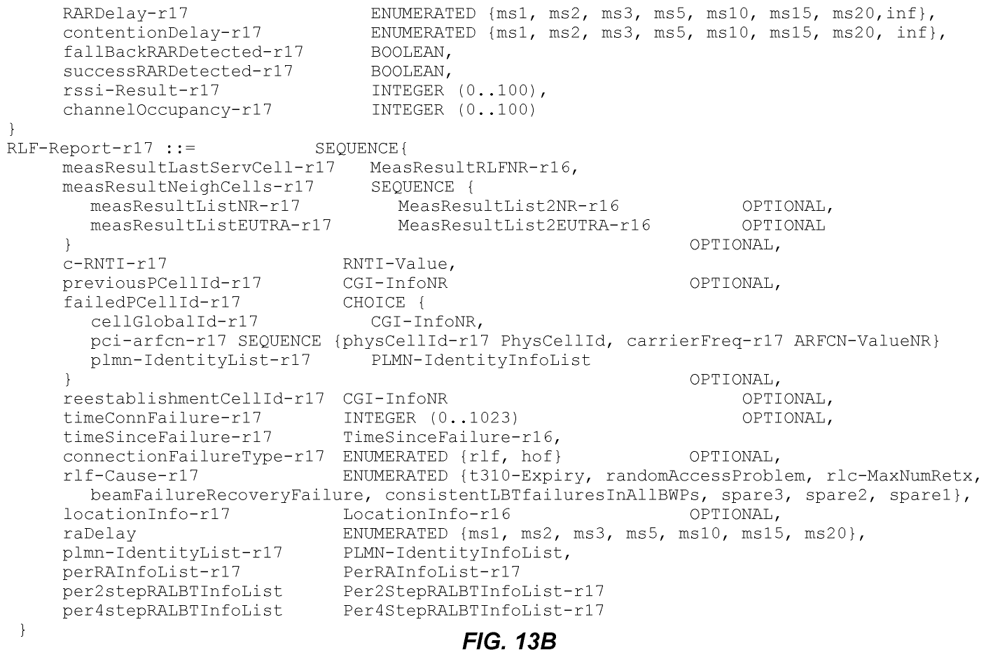

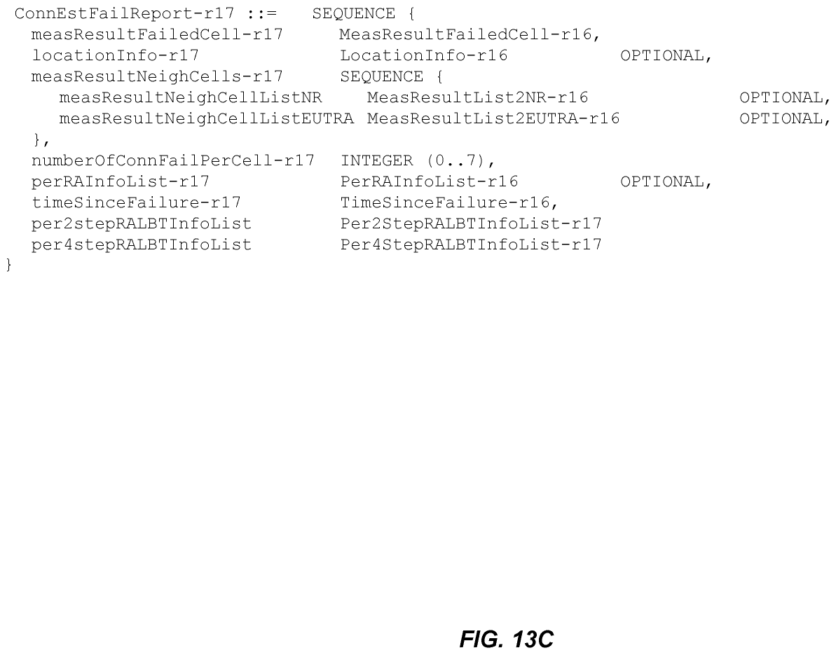

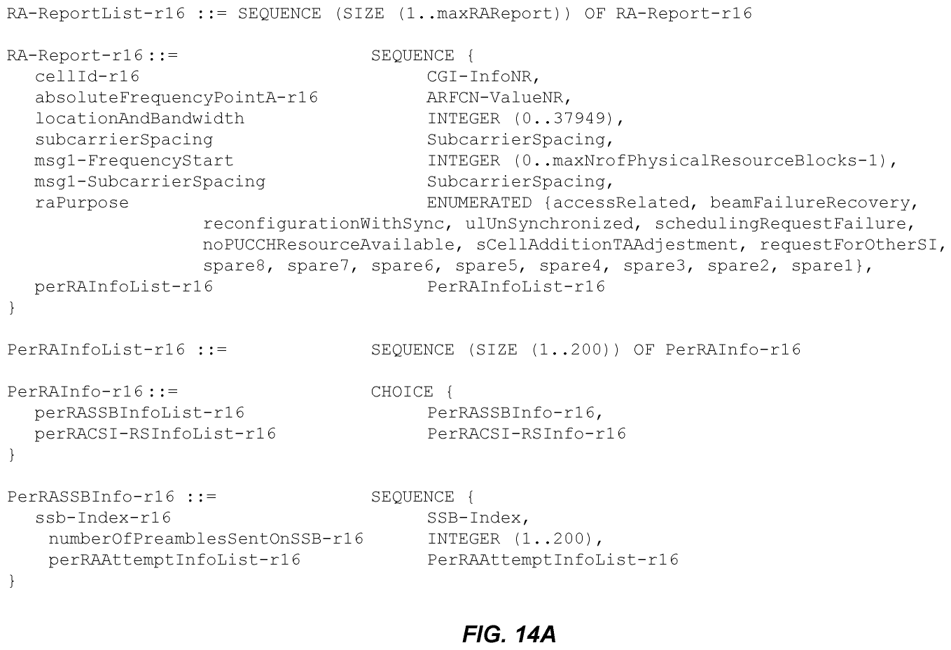

FIGS. 12, 13A, 13B, and 13C illustrate example ASN.1 signaling definitions that are usable together and consistent with examples of the second signaling embodiment discussed above. In FIG. 12, the definition of certain traditional IEs are essentially consistent with that shown in FIG. 2. In FIGS. 13A, 13B, and 13C, new and modified IEs define further signaling for reporting one or more of the statistics regarding RA discussed above.

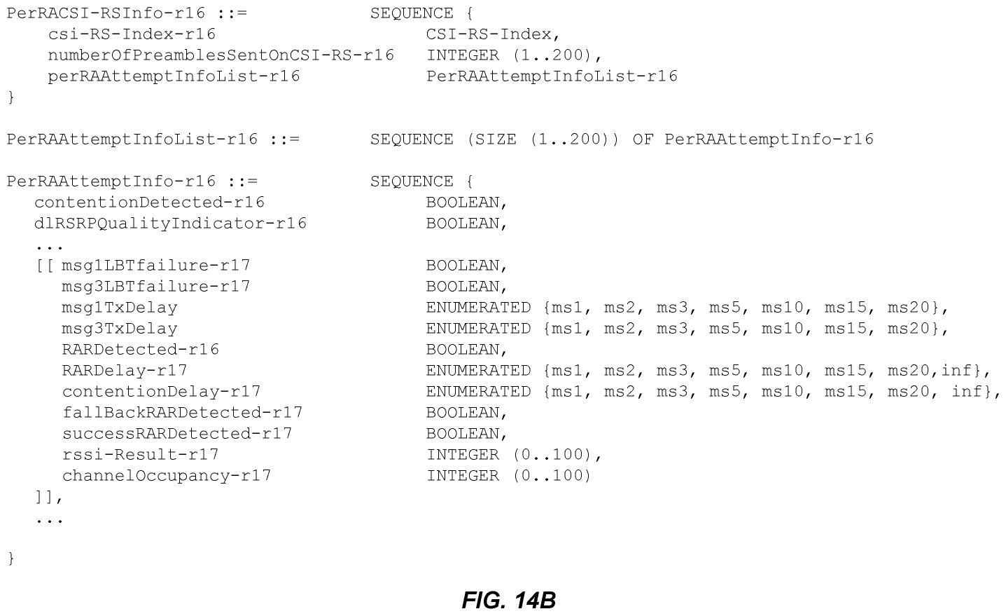

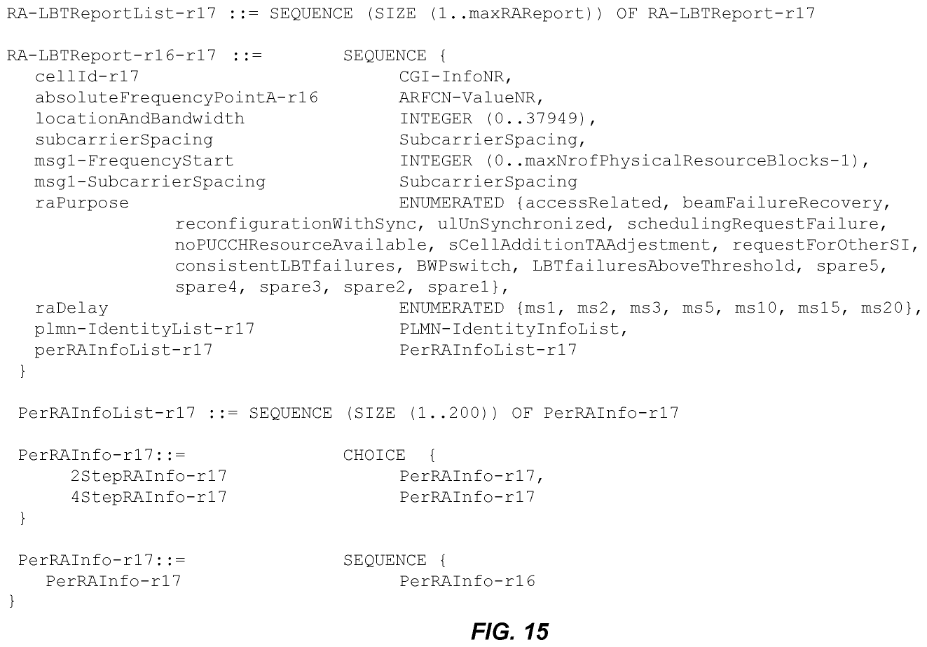

In a third signaling embodiment, a separate LBT report is included separately from the RLF/RACH report. The UE may add the LBT information into such a report in response to one or more of the events previously discussed. FIGS. 14A, 14B, and 15 illustrate example ASN.1 signaling definitions that are usable together and consistent with examples of this third signaling embodiment.

In FIGS. 14A and 14B, the definition of certain traditional IEs are modified to incorporate additional information as discussed above in similar fashion in many respects to that illustrated in FIG. 10 and as discussed in the corresponding description. In FIG. 15, examples of new IEs are shown that define signaling useful for providing an LBT report to the network (e.g., using a new RA-LBTReport data structure) in a manner consistent with the third signaling embodiment described above. The differences in signaling between, e.g., the RA-Report-r16 IE and the new RA-LBTReport-r16-r17 IE can be appreciated by comparing the ASN.1 of FIGS. 14A and 14B against that of FIG. 15. Although several differences are present, one such difference that may be of particular note is that a 2StepRAInfo-r17 IE and a 4StepRAInfo-r17 IE are provided in a CHOICE block, such that each PerRAInfo-r17 item in the PerRAInfoList-r17 can provide either 2-step RACH or 4-step RACH information, as discussed above.

The diagnostic information collected and reported by the UE 105 on the different RACH access procedures described in any of the embodiments above can be signaled between different RAN nodes (e.g., from one access node 110 to another).

In some such embodiments, the diagnostic information is signaled in the form of a report from the gNB-CU-CP to the gNB-DU. Because the reporting of RACH information from the UE 105 to the access node 110 as described herein happens at the RRC level, according to embodiments this information is received at the access node 110 by the gNB-CU-CP. That said, the management of RACH resources and configuration is controlled by the gNB-DU. Accordingly, embodiments of the present disclosure include signaling such RACH information to the gNB-DU to allow the gNB-DU to determine, based on information in the RACH report regarding the status of the configured RACH resources, whether such configuration needs to be modified (e.g., optimized), whether there are issues to be solved at coverage level, whether it is opportune to choose one type of RACH access versus another (e.g. 2-step RACH vs 4-step RACH), and/or other similar decisions.

For example, the gNB-DU may determine from the received RACH report that there is a consistent failure in the reception of msgA in the 2-step RACH procedure, but there is no equivalent failure in the reception of msg1 in a 4-step RACH procedure. From this, the gNB-DU may determine that the radio channel conditions at the edge of a given beam area are such to allow reception of a message of the size of msg1. From this, the gNB-DU may either decide to use only 4-step RACH procedures for access to the particular cell/beam where the events have been monitored and/or may decide to reduce the coverage of such beam so that UEs attempting to RACH to such beam would do so when they are closer to the UL receiver.

It should be noted that the actions described above on determining more optimal configurations from the content of the RACH report described herein could be performed by a node different from the gNB-DU or access node 110, provided that such node receives all the relevant information.

In another embodiment, the RACH information described herein and grouped in a RACH report provided by the UE 105 to the access node 110 (or other RAN node) serving it, may be forwarded to other neighbor nodes for the purpose of coverage and capacity enhancement/optimization for 2-step RACH access. For example, if one or more of the RACH reports described herein reveal that reception of msgA in 2-step RACH procedures towards a given beam consistently failed, a possible root cause of the failure may be that interference on the uplink RACH resources is high. A neighbor access node learning about such condition may decide to reduce the amount of interference generated towards the beam subject to the failed RACH access, e.g. by reconfiguring RACH resources on its served cells in an attempt to decouple its own RACH resources and those of the neighbor cell.

In view of the above, the access node 110 (e.g., gNB) may respond to receiving LBT information as discussed herein in one or more ways, e.g., to improve conditions for one or more UEs 105 interacting with the access node 110 via random access. In some embodiments, the access node 110 changes the preamble resource allocation depending on the amount of LBT the UE 105 experienced in the frequency in which random access was performed. For example, the access node 110 may change the initial BWP used for random access purposes and may exclude the most problematic BWPs at least from being used for random access purposes.

In some embodiments, the access node 110 may determine that a node hidden from the UE 105 is present based on the UE 105 indicating failures in msg2/msgB reception. That is, the access node 110 may determine that the UE 105 is suffering from certain negative effects of a hidden node. Accordingly, the access node 110 may change the Physical Downlink Shared Channel (PDSCH) resource allocation at least for msg2/msgB transmission. Similarly, the access node 110 may avoid allocating PUSCH resources for the msg3 (during 4-step RACH or after 2-step fallback) in those resource blocks in which previous msg3 transmissions suffered LBT failures.

In some embodiments, the access node 110 may determine that another access node (e.g., a gNB belonging to a different PLMN; a Wi-Fi station) is operating in the same frequency in which the UE 105 attempted random access and interfered with that random access.

In some embodiments, the access node 110 may determine whether to allocate 2-step RACH resources and/or 4-step RACH resources for a serving cell based of the content of 2-step and/or 4-step RACH reporting that includes LBT information of at least that serving cell. For example, the access node 110 may determine whether to allocate 2-step RACH resources and refrain from allocating 4-step RACH resources based on whether an RSRP, RSSI, channel occupancy, and/or number of LBT failures exceeds a threshold. Similarly, the access node 110 may determine whether to allocate 4-step RACH resources and refrain from allocating 2-step RACH resources based on whether the RSRP, RSSI, channel occupancy, and/or number of LBT failures exceeds the threshold.

Indeed, in some embodiments, the access node 110 controls the allocation of RACH resources based on one or more factors relative to certain respective thresholds. In one such example, the access node 110 may allocate 2-step RACH resources (e.g., by maintaining a previous allocation of 2-step RACH resources or configuring new ones) in the cell responsive to the downlink RSRP being above a certain value and either LBT failures exceeding a certain threshold, the RSSI falling below a certain threshold, and/or the Channel occupancy exceeding a threshold. Correspondingly, in some embodiments, should any of these criteria fail to be met, the access node 110 may instead allocate 4-step RACH resources (e.g., by maintaining a previous allocation of 4-step RACH resources or configuring new ones).

In some embodiments, the access node 110 reallocates RACH resources from 2-step RACH to 4-step-RACH or from 4-step RACH to 2-step RACH based on any of the 2/4-step RACH reporting discussed above (e.g., based on the LBT information contained therein).

In some embodiments, the access node 110 keeps for this cell and this BWP both the 2-step and 4-step RACH resources, and it signals the aforementioned threshold to the UE (e.g., in the System Information Block (SIB)) so that the UE can autonomously determine whether to use 2-step RACH resources or 4-step RACH resources for random access.

It should be further noted that a UE 105 as described above may perform any of the processing described herein by implementing any functional means or units. In one embodiment, for example, the UE 105 comprises respective circuits configured to perform the steps shown in FIG. 8. The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory may store program code that, when executed by the one or more microprocessors, carries out the techniques described herein. That is, in some embodiments memory of the UE 105 contains instructions executable by processing circuitry whereby the UE 105 is configured to carry out the processing herein.

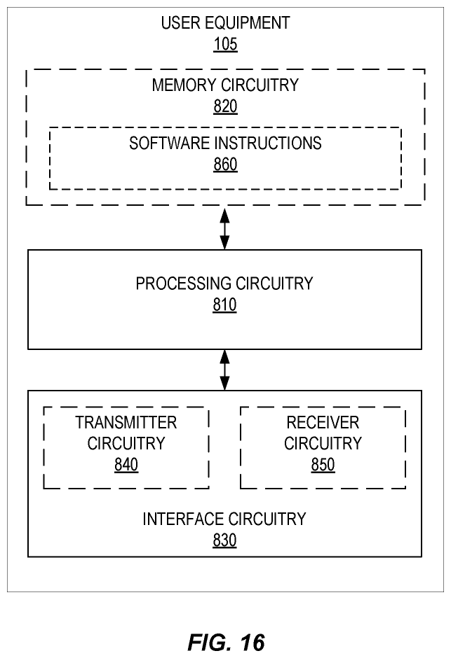

FIG. 16 illustrates additional details of a UE 105 in accordance with one or more embodiments. The UE 105 comprises processing circuitry 810 and interface circuitry 830. The processing circuitry 810 is communicatively coupled to the interface circuitry 830, e.g., via one or more buses. In some embodiments, the UE 105 further comprises memory circuitry 820 that is communicatively coupled to the processing circuitry 810, e.g., via one or more buses. According to particular embodiments, the processing circuitry 810 is configured to perform one or more of the methods described herein (e.g., the method 400 illustrated in FIG. 8).

The processing circuitry 810 of the UE 105 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 810 may be programmable hardware capable of executing software instructions 860 of a computer program stored in memory circuitry 820 whereby the processing circuitry 810 is configured. The memory circuitry 820 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 830 may be a controller hub configured to control the input and output (I/O) data paths of the UE 105. Such I/O data paths may include data paths for exchanging signals over a communications network, data paths for exchanging signals with a user, and/or data paths for exchanging data internally among components of the UE 105. For example, the interface circuitry 830 may comprise a transceiver configured to send and receive communication signals over one or more of a cellular network, Ethernet network, or optical network. The interface circuitry 830 may be implemented as a unitary physical component, or as a plurality of physical components that are contiguously or separately arranged, any of which may be communicatively coupled to any other, or may communicate with any other via the processing circuitry 810. For example, the interface circuitry 830 may comprise transmitter circuitry 840 configured to send communication signals over a communications network and receiver circuitry 850 configured to receive communication signals over the communications network. Other embodiments may include other permutations and/or arrangements of the above and/or their equivalents.

According to embodiments of the UE 105 illustrated in FIG. 16, the processing circuitry 810 is configured to make a plurality of attempts at random access to the access node (110), and transmit, to the access node (110), a report comprising Listen Before Talk (LBT) diagnostic data for each of the attempts at random access.

Other embodiments of the present disclosure include corresponding computer programs. In one such embodiment, the computer program comprises instructions 860 which, when executed on processing circuitry 830 of a UE 105, cause the UE 105 to carry out any of the UE processing described above. A computer program in this regard may comprise one or more code modules corresponding to the means or units described above.

Embodiments further include a computer program product comprising program code portions for performing the steps of any of the embodiments herein when the computer program product is executed by a UE 105. This computer program product may be stored on a computer readable recording medium.

It should be further noted that an access node 110 as described above may perform any of the processing described herein by implementing any functional means or units. In one embodiment, for example, the access node 110 comprises respective circuits configured to perform the steps shown in FIG. 9. The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory may store program code that, when executed by the one or more microprocessors, carries out the techniques described herein. That is, in some embodiments, memory of the access node 110 contains instructions executable by processing circuitry whereby the access node 110 is configured to carry out the processing herein.

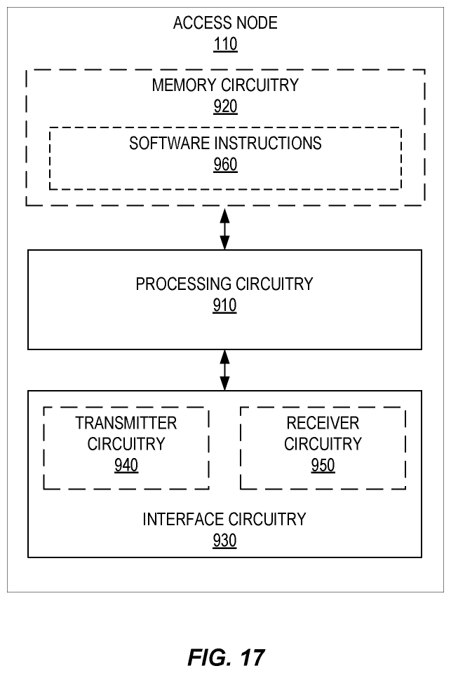

FIG. 17 illustrates additional details of an access node 110 in accordance with one or more embodiments. The access node 110 comprises processing circuitry 910 and interface circuitry 930. The processing circuitry 910 is communicatively coupled to the interface circuitry 930, e.g., via one or more buses. In some embodiments, the access node 110 further comprises memory circuitry 920 that is communicatively coupled to the processing circuitry 910, e.g., via one or more buses. According to particular embodiments, the processing circuitry 910 is configured to perform one or more of the methods described herein (e.g., the method 450 illustrated in FIG. 9).

The processing circuitry 910 of the access node 110 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 910 may be programmable hardware capable of executing software instructions 960 of a computer program stored in memory circuitry 920 whereby the processing circuitry 910 is configured. The memory circuitry 920 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 930 may be a controller hub configured to control the input and output (I/O) data paths of the access node 110. Such I/O data paths may include data paths for exchanging signals over a communications network, data paths for exchanging signals with a user, and/or data paths for exchanging data internally among components of the access node 110. For example, the interface circuitry 930 may comprise a transceiver configured to send and receive communication signals over one or more of a cellular network, Ethernet network, or optical network. The interface circuitry 930 may be implemented as a unitary physical component, or as a plurality of physical components that are contiguously or separately arranged, any of which may be communicatively coupled to any other, or may communicate with any other via the processing circuitry 910. For example, the interface circuitry 930 may comprise transmitter circuitry 940 configured to send communication signals over a communications network and receiver circuitry 950 configured to receive communication signals over the communications network. Other embodiments may include other permutations and/or arrangements of the above and/or their equivalents.

According to embodiments of the access node illustrated in FIG. 17, the processing circuitry 910 is configured to receive, from a UE (105), a report comprising Listen Before Talk (LBT) diagnostic data for each of a plurality of attempts at random access to the access node (110) performed by the UE (105), and configure the UE (105) with an adjusted random access resource allocation based on the LBT diagnostic data of at least one of the attempts at random access.

Other embodiments of the present disclosure include corresponding computer programs. In one such embodiment, the computer program comprises instructions which, when executed on processing circuitry 930 of an access node 110, cause the access node 110 to carry out any of the access node processing described above. A computer program in this regard may comprise one or more code modules corresponding to the means or units described above.

Embodiments further include a computer program product comprising program code portions for performing the steps of any of the embodiments herein when the computer program product is executed by a computing device. This computer program product may be stored on a computer readable recording medium.

Embodiments further include a carrier containing one or more of the computer programs discussed above. This carrier may comprise one of an electronic signal, optical signal, radio signal, or computer readable storage medium.

Additional embodiments will now be described. At least some of these embodiments may be described as applicable in certain contexts and/or wireless network types for illustrative purposes, but the embodiments are similarly applicable in other contexts and/or wireless network types not explicitly described.

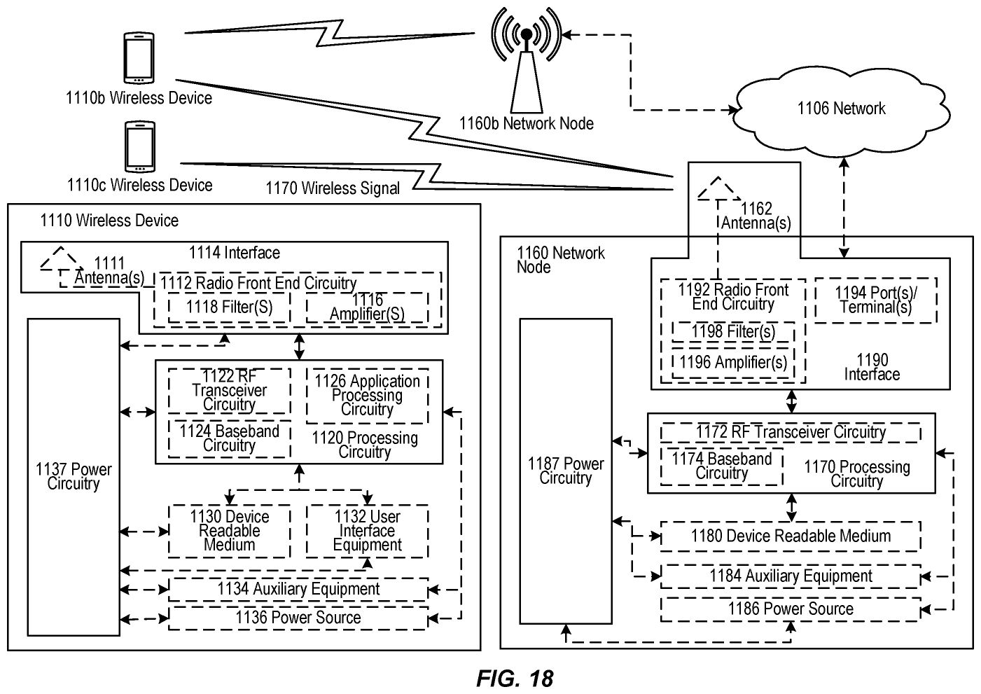

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), and base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 18 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

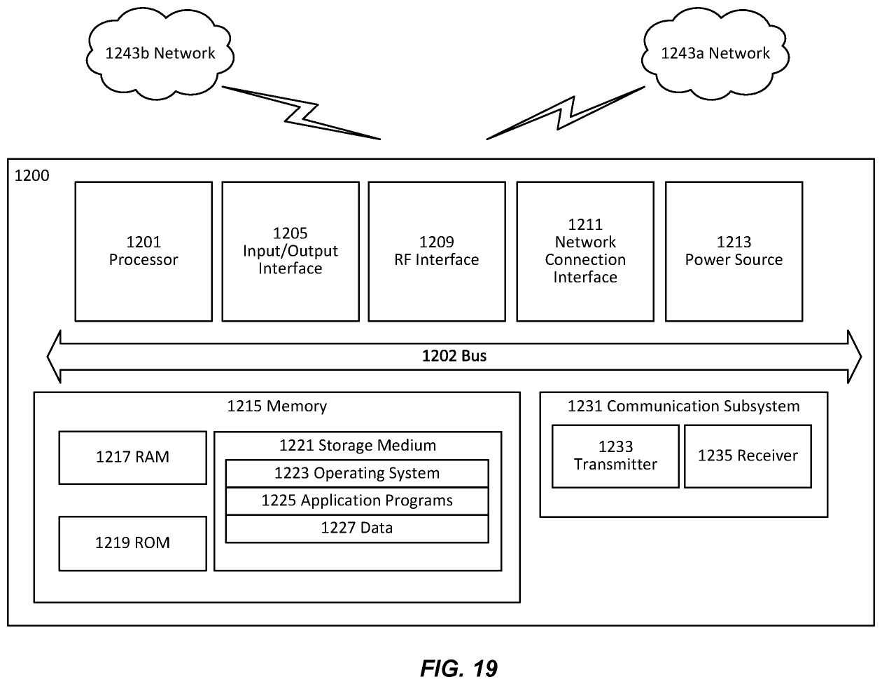

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 19, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 19, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

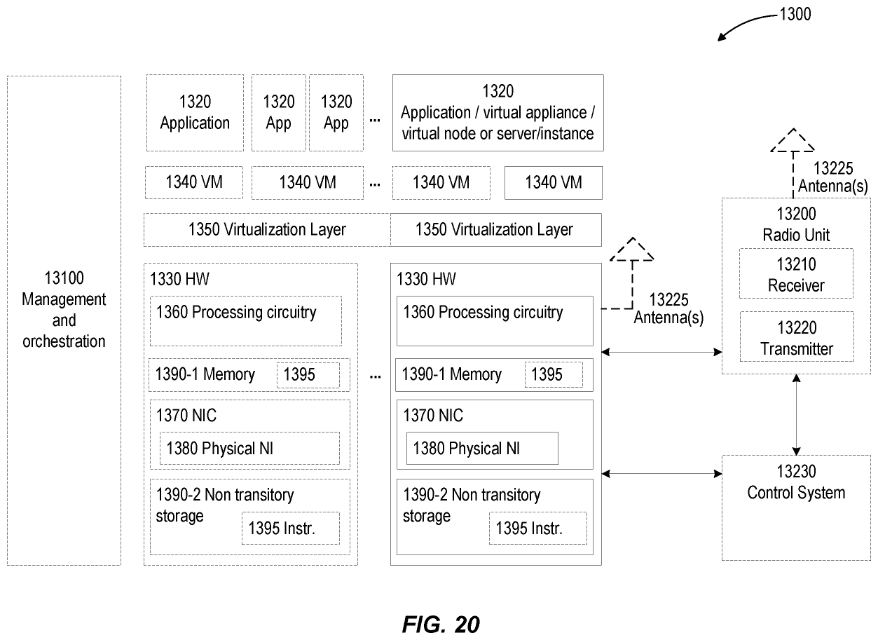

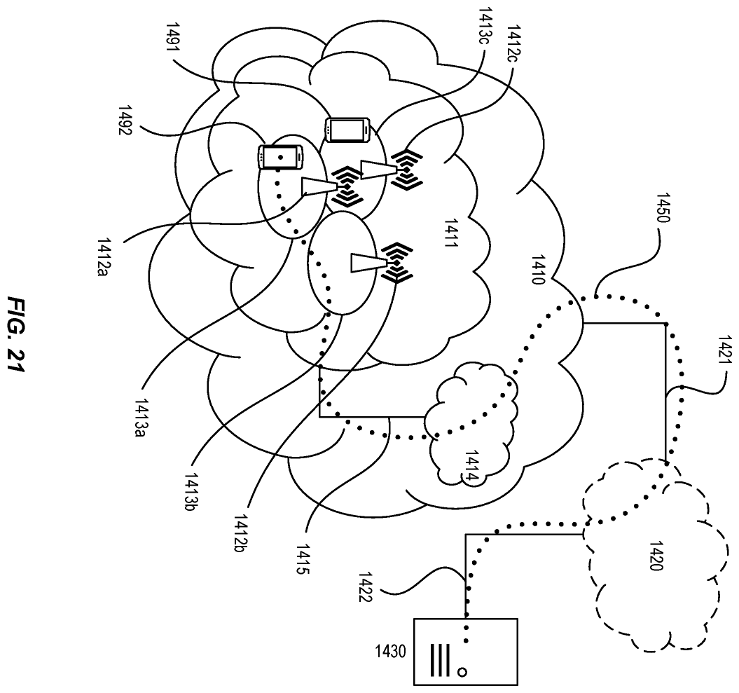

FIG. 20 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 20, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 20.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be effected with the use of control system 13230 which may alternatively be used for communication between the hardware nodes 1330 and radio units 13200.

FIG. 21 illustrates a telecommunication network connected via an intermediate network to a host computer in accordance with some embodiments. In particular, with reference to FIG. 21, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, and a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 21 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

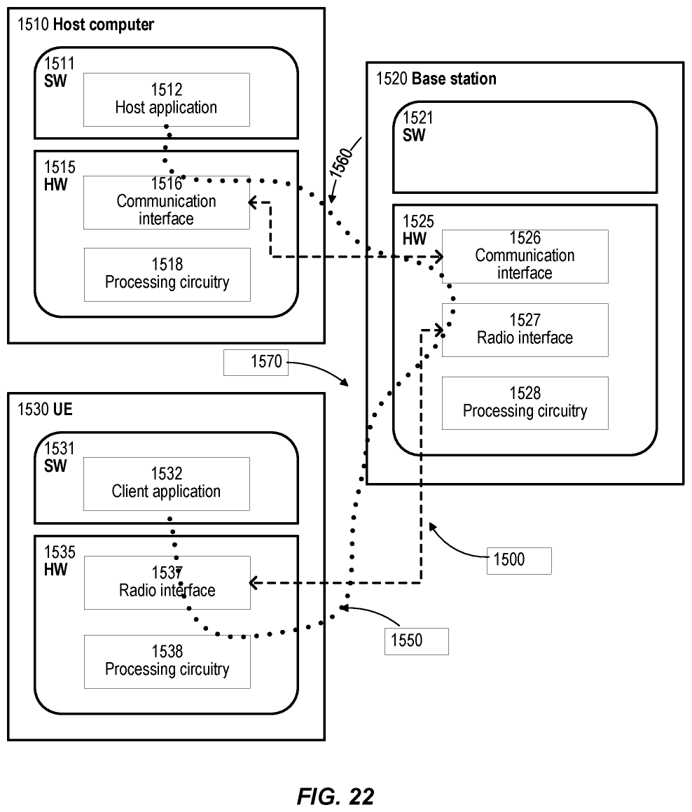

Example implementations, in accordance with an embodiment, of the UE, base station and host computer discussed in the preceding paragraphs will now be described with reference to FIG. 22. FIG. 22 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 22) served by base station 1520. Communication interface 1526 may be configured to facilitate connection 1560 to host computer 1510. Connection 1560 may be direct or it may pass through a core network (not shown in FIG. 22) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 22 may be similar or identical to host computer 1430, one of base stations 1412a, 1412b, 1412c and one of UEs 1491, 1492 of FIG. 21, respectively. This is to say, the inner workings of these entities may be as shown in FIG. 22 and independently, the surrounding network topology may be that of FIG. 21.

In FIG. 22, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may reduce the total amount of time required for a UE to perform measurements of radio conditions, and thereby provide benefits such as increased throughput and/or decreased latency.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

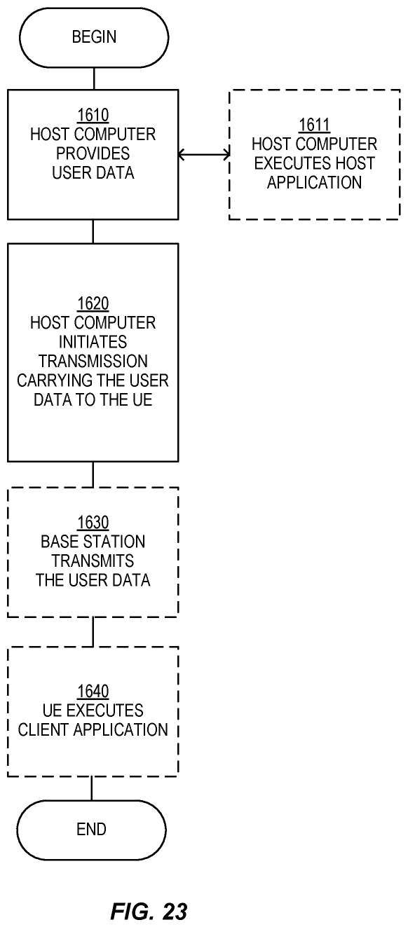

FIG. 23 is a flowchart illustrating a method implemented in a communication system, in accordance with one embodiment. The communication system includes a host computer, a base station and a UE which may be those described with reference to FIG. 21 and FIG. 22. For simplicity of the present disclosure, only drawing references to FIG. 23 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

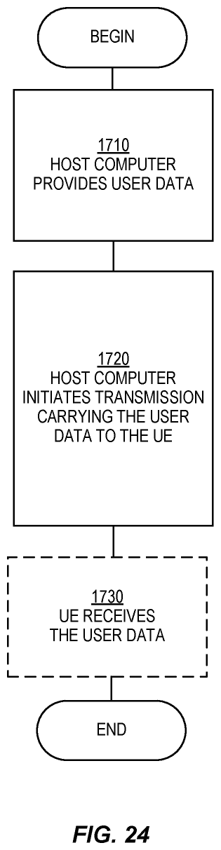

FIG. 24 is a flowchart illustrating a method implemented in a communication system, in accordance with one embodiment. The communication system includes a host computer, a base station and a UE which may be those described with reference to FIG. 21 and FIG. 22. For simplicity of the present disclosure, only drawing references to FIG. 24 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

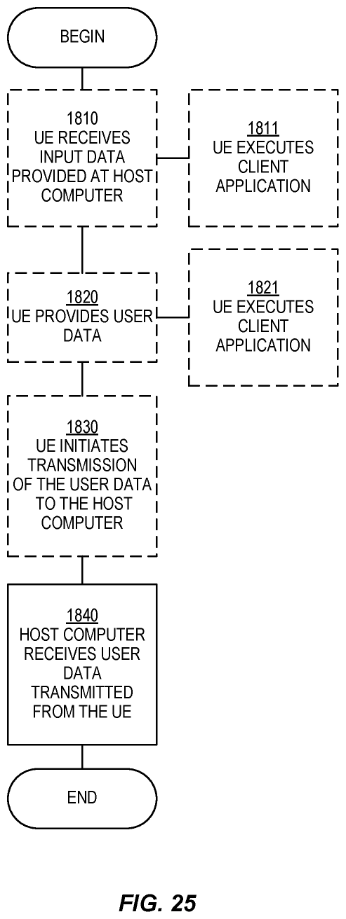

FIG. 25 is a flowchart illustrating a method implemented in a communication system, in accordance with one embodiment. The communication system includes a host computer, a base station and a UE which may be those described with reference to FIG. 21 and FIG. 22. For simplicity of the present disclosure, only drawing references to FIG. 25 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

FIG. 26 is a flowchart illustrating a method implemented in a communication system, in accordance with one embodiment. The communication system includes a host computer, a base station and a UE which may be those described with reference to FIG. 21 and FIG. 22. For simplicity of the present disclosure, only drawing references to FIG. 26 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-43. (canceled)

44. A method of reporting random access information to an access node, performed by a user equipment, UE, in a wireless communication network, the method comprising:
making a plurality of attempts at random access to the access node; and
transmitting, to the access node, a report comprising Listen Before Talk (LBT) diagnostic data for each of the attempts at random access.

45. The method of claim 44, further comprising:
receiving a threshold from the access node; and
selecting a 2-step random access channel resource responsive to detecting that signal quality on a downlink between the UE and the access node is above the threshold;
wherein at least one of the attempts uses the selected 2-step random access channel resource.

46. The method of claim 44, wherein at least one of the attempts at random access is to a Special Cell, wherein the method further comprises:
experiencing LBT failures on a bandwidth part (BWP) in at least one of the attempts at random access to the Special Cell; and
switching to a different BWP responsive to experiencing the LBT failures;
wherein making at least one of the attempts comprises uses the different BWP for a subsequent attempt at random access to the Special Cell.

47. The method of claim 44, further comprising selecting a 4-step random access channel resource responsive to experiencing LBT failures in a previous one of the attempts, wherein at least one of the attempts uses the selected 4-step random access channel resource.

48. The method of claim 44, further comprising experiencing multiple LBT failures with respect to a failed attempt of the plurality of attempts at random access to a Special Cell, wherein transmitting the report comprising the LBT diagnostic data is responsive to experiencing the multiple LBT failures.

49. The method of claim 44, further comprising experiencing multiple LBT failures in each of a plurality of BWPs available for random access procedures with the access node, wherein transmitting the report comprising the LBT diagnostic data comprises transmitting a Radio Link Failure report responsive to experiencing the multiple LBT failures.

50. The method of claim 44, further comprising postponing transmission of a message for a given attempt of the plurality of attempts at random access responsive to experiencing an LBT failure, wherein transmitting the report comprising the LBT diagnostic data comprises transmitting an LBT report responsive to experiencing the LBT failure.

51. The method of claim 44, further comprising experiencing a number of LBT failures in excess of a threshold for a given attempt of the plurality of attempts at random access, wherein transmitting the report comprising the LBT diagnostic data comprises transmitting an LBT report responsive to experiencing the number of LBT failures in excess of the threshold.

52. The method of claim 44, further comprising, responsive to experiencing a plurality of LBT failures using a BWP of a serving cell of the access node, refraining from transmitting on an uplink of a Secondary Cell of the serving cell for attempts of the plurality of attempts subsequent to the plurality of LBT failures, wherein transmitting the report comprising the LBT diagnostic data comprises transmitting an LBT report responsive to experiencing the plurality of LBT failures.

53. The method of claim 44, further comprising, responsive to experiencing a plurality of LBT failures using a BWP of a serving cell of the access node, switching to a different BWP for attempts of the plurality of attempts subsequent to the plurality of LBT failures, wherein transmitting the report comprising the LBT diagnostic data comprises transmitting an LBT report responsive to experiencing the LBT failure.

54. The method of claim 44, further comprising receiving an adjusted random access resource allocation from the access node in response to the report comprising the LBT diagnostic data, and attempting random access to the access node using the adjusted random access resource allocation, wherein the adjusted random access resource allocation:
excludes a BWP used for the at least one of the attempts at random access and includes a different BWP in the random access resource allocation; and/or
comprises a changed Physical Downlink Shared Channel resource allocated for responding to a random access preamble transmission from the UE; and/or
excludes a Physical Uplink Shared Channel resource used in at least one of the attempts at random access; and/or
replaces one of a 2-step Random Access Channel, RACH, resource allocation and a 4-step RACH resource allocation with the other of the 2-step RACH resource allocation and the 4-step RACH resource allocation.

55. The method of claim 54, wherein the adjusted random access resource allocation replaces the 2-step RACH resource allocation with the 4-step RACH resource allocation responsive to a signal quality metric indicated in the LBT diagnostic data being below a signal quality threshold.

56. The method of claim 54, wherein the adjusted random access resource allocation replaces the 4-step RACH resource allocation with the 2-step RACH resource allocation responsive to:
a signal quality metric indicated in the LBT diagnostic data exceeding a signal quality threshold; and/or
a further signal quality metric indicated in the LBT diagnostic data being below a further signal quality threshold; and/or
a number of LBT failures indicated in the LBT diagnostic data exceeding an LBT failure threshold; and/or
a channel occupancy indicated in the LBT diagnostic data exceeding a channel occupancy threshold.

57. The method of claim 54, wherein:
the adjusted random access resource allocation comprises both the 2-step RACH resource allocation and the 4-step RACH resource allocation; and
the method further comprises selecting between using the 2-step RACH resource allocation and the 4-step RACH resource allocation in a subsequent random access attempt based on a signal quality threshold received from the access node.

58. The method of claim 44, further comprising:
measuring, for each of the attempts at random access, an amount of time between a first event at the UE with respect to an initial random access message in the attempt, and a second event at the UE; and
including the measured amount of time between the first and second events in the LBT diagnostic data transmitted to the access node.

59. The method of claim 58, wherein, for each of the attempts:
the first event is a triggering of the UE to perform an LBT procedure in order to transmit the initial random access message; and
the second event is one of:
a determination by the UE that transmission of the initial random access message, after the LBT procedure, was successful;
a switching of BWPs by the UE after failure of the LBT procedure;
receipt of a response to the initial random access message after the LBT procedure succeeded;
receipt, after transmission of the initial random access message failed, of a response to a further initial random access message transmitted by the UE in a subsequent attempt;
expiration of a random access response window timer.

60. The method of claim 59, further comprising:
measuring, for at least one of the attempts, an amount of time spent waiting for a response to the initial random access message; and
including the amount of time spent waiting for the response to the initial random access message in the LBT diagnostic data transmitted to the access node.

61. The method of claim 44, further comprising:
measuring, for at least one of the attempts at random access, an amount of time between a third event at the UE with respect to a message on a Physical Uplink Shared Channel in the attempt, and a fourth event at the UE; and
including the measured amount of time between the third and fourth events in the LBT diagnostic data transmitted to the access node;
wherein, for each of the at least one of the attempts, the third event is a triggering of the UE to perform an LBT procedure in order to transmit the message on the Physical Uplink Shared Channel, and the fourth event is one of:
a determination by the UE that transmission of the message on the Physical Uplink Shared Channel, after the LBT procedure, was successful;
receipt of a response to the message on the Physical Uplink Shared Channel after the LBT procedure succeeded; or
expiration of a random access contention resolution timer.

62. The method of claim 61, further comprising:
measuring, for at least one of the attempts, an amount of time spent waiting for the message on the Physical Uplink Shared Channel; and
including the amount of time spent waiting for the response to the message on the Physical Uplink Shared Channel in the LBT diagnostic data transmitted to the access node.

63. The method of claim 44, further comprising:
measuring, for at least one of the attempts at random access, an amount of time between a triggering of the UE to perform an LBT procedure in order to transmit an initial random access message comprising a contention resolution identity and a further event at the UE; and
including the amount of time between the triggering and the further event in the LBT diagnostic data transmitted to the access node;
wherein, for each of the at least one of the attempts, the further event at the UE is one of:
receiving a successRAR message comprising the contention resolution identity in response to the initial random access message after the LBT procedure succeeded;
receiving a contention resolution message comprising the contention resolution identity in response to a Physical Uplink Shared Channel transmission made by the UE in the attempt;
reporting a problem with the attempt;
detecting that reception of the response to the initial random access message failed;
detecting that reception of the response to the Physical Uplink Shared Channel transmission failed.

64. A user equipment comprising:
interface circuitry configured for communication with one or more serving cells of a wireless communication network; and
processing circuitry configured to:
make a plurality of attempts at random access to an access node; and
transmit, to the access node, a report comprising Listen Before Talk (LBT) diagnostic data for each of the attempts at random access.

65. A non-transitory computer readable medium storing a computer program product for controlling a programmable user equipment, the computer program product comprising software instructions that, when run on the programmable user equipment, cause the programmable user equipment to:
make a plurality of attempts at random access to an access node; and
transmit, to the access node, a report comprising Listen Before Talk (LBT) diagnostic data for each of the attempts at random access.
